(19) United States
(12) Patent Application Publication
(10) Pub. No.: US 2025/0108456 A1
(43) Pub. Date: Apr. 3, 2025

(54) LASER PROCESSING HEAD AND LASER PROCESSING MACHINE

(71) Applicant: Mitsubishi Electric Corporation, Tokyo (JP)

(72) Inventors: Hidekazu NAKAI, Tokyo (JP); Nobutaka KOBAYASHI, Tokyo (JP); Takayoshi HORIGUCHI, Tokyo (JP); Kazuya HORIO, Tokyo (JP); Ryogo KOBA, Tokyo (JP)

(73) Assignee: Mitsubishi Electric Corporation, Tokyo (JP)

(21) Appl. No.: 18/836,447

(22) PCT Filed: Dec. 6, 2022
(86) PCT No.: PCT/JP2022/044975

§ 371 Date: Aug. 7, 2024

(30) Foreign Application Priority Data
Feb. 22, 2022 (JP) 2022-025926

(51) Int. Cl. B23K 26/21; B23K 26/70

(52) U.S. Cl. CPC B23K 26/21; B23K 26/70

(57) ABSTRACT

A laser processing head includes a first processing head unit and a second processing head unit. An end portion of the first processing head unit facing the second processing head unit is formed with a first inclined surface. An end portion of the second processing head unit facing the first processing head unit is formed with a second inclined surface parallel to the first inclined surface. At least one of the first inclined surface or the second inclined surface is provided with an attraction member. At least one of the first inclined surface or the second inclined surface is provided with a movable pin protruding toward the other thereof and energized toward the other thereof. At least the other of the first inclined surface or the second inclined surface is provided with a pin seat. Each of the movable pin and the pin seat is plural in number.

### FIELD

The present disclosure relates to a laser processing head including an attraction member and a laser processing machine including the laser processing head.

### BACKGROUND

There is conventionally known a laser processing machine including a laser processing head that irradiates a workpiece with a laser beam and a driving means that moves the laser processing head, in which the driving means moves the laser processing head relative to the workpiece along a preset locus (or trajectory) to process the workpiece.

In recent years, regarding laser processing machines, the speed of movement of processing heads has been increasing in order to shorten processing time for workpieces. With the increase in the speed of movement of processing heads, there is an increase in an impact force applied to a laser processing head when the laser processing head collides with a workpiece due to an erroneous operation of a worker, a failure of a laser processing machine, or the like, and thus the laser processing head is more likely to be damaged.

Therefore, a laser processing head has been developed in which an impact force applied to the laser processing head at a time of collision is reduced. For example, Patent Literature 1 discloses a laser processing head in which the laser processing head is divided into two, i.e., a tip end portion and a main body portion, in an extending direction of the laser processing head, each of a division surface of the tip end portion and a division surface of the main body portion is inclined with respect to the extending direction of the laser processing head, and magnets are mounted on each of the division surface of the tip end portion and the division surface of the main body portion. The tip end portion is separably coupled to the main body portion via the magnets.

In the laser processing head disclosed in Patent Literature 1, when the tip end portion collides with a workpiece and an impact force exceeding an attraction force of the magnets is applied to the tip end portion, the tip end portion is separated from the main body portion, Therefore, an excessive impact force is not applied to the laser processing head, and damage to the laser processing head is reduced. In addition, in the laser processing head disclosed in Patent Literature 1, since each of the division surface of the tip end portion and the division surface of the main body portion is inclined, when the laser processing head collides with the workpiece while moving downward, the tip end portion slides to move along an inclination direction of the division surface. Consequently, the impact force applied to the laser processing head is relieved, and damage to the laser processing head is reduced.

### CITATION LIST

### Patent Literature

Patent Literature 1: Japanese Examined Utility Model Application Publication No. H1-17427

### SUMMARY OF INVENTION

### Problem to be Solved by the Invention

However, in the laser processing head disclosed in Patent Literature 1, since there is no positioning mechanism that performs positioning of the tip end portion and the main body portion, the positions of the tip end portion and the main body portion are not uniquely determined. Consequently, when the tip end portion and the main body portion are once separated and then recoupled, deviation in a positional relationship between the tip end portion and the main body portion is likely to occur between before separation and after recoupling.

The present disclosure has been made in view of the above, and an object of thereof is to provide a laser processing head capable of improving positioning accuracy when a first processing head unit and a second processing head unit are coupled.

### Means to Solve the Problem

In order to solve the above-described problem and achieve the object, a laser processing head according to the present disclosure is a laser processing head that has an optical path hole formed therein for passing a laser beam and extends in a first direction, and includes a first processing head unit and a second processing head unit disposed side by side with the first processing head unit in the first direction and coupled to the first processing head unit in a separable manner. An end portion of the first processing head unit facing the second processing head unit is formed with a first inclined surface inclined with respect to the first direction. An end portion of the second processing head unit facing the first processing head unit is formed with a second inclined surface parallel to the first inclined surface. At least one of the first inclined surface or the second inclined surface is provided with an attraction member that couples the first processing head unit and the second processing head unit in a separable manner. At least one of the first inclined surface or the second inclined surface is provided with a movable pin protruding toward the other thereof and energized toward the other thereof. At least the other of the first inclined surface or the second inclined surface is provided with a pin seat into which the movable pin is inserted. Each of the movable pin and the pin seat is plural in number.

### Effects of the Invention

A laser processing head according to the present disclosure achieves an effect that it is possible to improve positioning accuracy when a first processing head unit and a second processing head unit are coupled.

### BRIEF DESCRIPTION OF DRAWINGS

FIG. 1 is a diagram illustrating a schematic configuration of an additive manufacturing apparatus according to a first embodiment.

FIG. 2 is a perspective view illustrating a laser processing head, a wire feeder, a wire straightener, and a height sensor in the first embodiment.

FIG. 3 is a perspective view illustrating the laser processing head in the first embodiment, and is a view illustrating a state in which a first processing head unit and a second processing head unit are coupled.

FIG. 4 is a perspective view illustrating the laser processing head in the first embodiment, and is a view illustrating a state in which the first processing head unit and the second processing head unit are separated.

FIG. 5 is a perspective view illustrating an end portion of the first processing head unit that faces the second processing head unit.

FIG. 6 is a perspective view illustrating an end portion of the second processing head unit that faces the first processing head unit.

FIG. 7 is a plan view illustrating the end portion of the first processing head unit that faces the second processing head unit.

FIG. 8 is a plan view illustrating the end portion of the second processing head unit that faces the first processing head unit.

FIG. 9 is a cross-sectional view taken along line IX-IX illustrated in FIG. 7.

FIG. 10 is a cross-sectional view taken along line X-X illustrated in FIG. 7.

FIG. 11 is a cross-sectional view taken along line XI-XI illustrated in FIG. 8.

FIG. 12 is a view schematically illustrating a movable pin.

FIG. 13 is a cross-sectional view taken along line XIII-XIII illustrated in FIG. 7.

FIG. 14 is a perspective view illustrating a magnet.

FIG. 15 is a perspective view illustrating the first processing head unit.

FIG. 16 is a perspective view illustrating the second processing head unit.

FIG. 17 is a cross-sectional view illustrating a state of the laser processing head at a time of a downward collision thereof, and is a view corresponding to the cross-sectional view taken along line IX-IX illustrated in FIG. 7.

FIG. 18 is a cross-sectional view illustrating a state of the laser processing head at the time of the downward collision thereof, and is a view corresponding to the cross-sectional view taken along line X-X illustrated in FIG. 7.

FIG. 19 is a cross-sectional view illustrating a state of the laser processing head at a time of a collision thereof in a Y-axis direction, and is a view corresponding to the cross-sectional view taken along line IX-IX illustrated in FIG. 7.

FIG. 20 is a perspective view illustrating a state of the laser processing head at a time of a collision thereof in an X-axis direction.

FIG. 21 is a perspective view illustrating an end portion of the first processing head unit of the laser processing head according to a first modification of the first embodiment, the end portion facing the second processing head unit.

FIG. 22 is a perspective view illustrating an end portion of the second processing head unit of the laser processing head according to the first modification of the first embodiment, the end portion facing the first processing head unit.

FIG. 23 is a cross-sectional view illustrating the laser processing head according to a second modification of the first embodiment, and is a view corresponding to the cross-sectional view taken along line IX-IX illustrated in FIG. 7.

FIG. 24 is a plan view illustrating an end portion of the second processing head unit of the laser processing head according to a third modification of the first embodiment, the end portion facing the first processing head unit.

FIG. 25 is a plan view illustrating an end portion of the first processing head unit of the laser processing head according to the third modification of the first embodiment, the end portion facing the second processing head unit.

FIG. 26 is a plan view illustrating an end portion of the second processing head unit of the laser processing head according to a fourth modification of the first embodiment, the end portion facing the first processing head unit,

FIG. 27 is a plan view illustrating an end portion of the first processing head unit of the laser processing head according to the fourth modification of the first embodiment, the end portion facing the second processing head unit,

FIG. 28 is a plan view illustrating an end portion of the second processing head unit of the laser processing head according to a fifth modification of the first embodiment, the end portion facing the first processing head unit.

FIG. 29 is a plan view illustrating an end portion of the first processing head unit of the laser processing head according to the fifth modification of the first embodiment, the end portion facing the second processing head unit.

FIG. 30 is a plan view illustrating an end portion of the second processing head unit of the laser processing head according to a sixth modification of the first embodiment, the end portion facing the first processing head unit.

FIG. 31 is a plan view illustrating an end portion of the first processing head unit of the laser processing head according to the sixth modification of the first embodiment, the end portion facing the second processing head unit.

FIG. 32 is a plan view illustrating an end portion of the second processing head unit of the laser processing head according to a seventh modification of the first embodiment, the end portion facing the first processing head unit.

FIG. 33 is a plan view illustrating an end portion of the first processing head unit of the laser processing head according to the seventh modification of the first embodiment, the end portion facing the second processing head unit,

FIG. 34 is a plan view illustrating an end portion of the second processing head unit of the laser processing head according to an eighth modification of the first embodiment, the end portion facing the first processing head unit.

FIG. 35 is a plan view illustrating an end portion of the first processing head unit of the laser processing head according to the eighth modification of the first embodiment, the end portion facing the second processing head unit,

FIG. 36 is a perspective view illustrating an end portion of the first processing head unit of the laser processing head according to a ninth modification of the first embodiment, the end portion facing the second processing head unit.

FIG. 37 is a perspective view illustrating an end portion of the first processing head unit of the laser processing head according to a tenth modification of the first embodiment, the end portion facing the second processing head unit.

FIG. 38 is a perspective view illustrating an end portion of the first processing head unit of the laser processing head according to an eleventh modification of the first embodiment, the end portion facing the second processing head unit.

FIG. 39 is a perspective view illustrating an end portion of the second processing head unit of the laser processing head according to the eleventh modification of the first embodiment, the end portion facing the first processing head unit.

FIG. 40 is a view schematically illustrating the movable pin of the laser processing head according to a twelfth modification of the first embodiment.

FIG. 41 is a view schematically illustrating the movable pin of the laser processing head according to a thirteenth modification of the first embodiment.

FIG. 42 is a perspective view illustrating an end portion of the second processing head unit of the laser processing head according to a fourteenth modification of the first embodiment, the end portion facing the first processing head unit.

FIG. 43 is a view schematically illustrating a pin seat of the laser processing head according to a fifteenth modification of the first embodiment.

FIG. 44 is an explanatory view for explaining a contact point between the movable pin and the pin seat.

FIG. 45 is an explanatory view for explaining the contact point between the movable pin and the pin seat, and is a view illustrating a case where a position of the contact point is different from that in FIG. 44.

FIG. 46 is a plan view illustrating an end portion of the first processing head unit of the laser processing head according to a sixteenth modification of the first embodiment, the end portion facing the second processing head unit.

FIG. 47 is a plan view illustrating an end portion of the first processing head unit of the laser processing head according to a seventeenth modification of the first embodiment, the end portion facing the second processing head unit.

FIG. 48 is a plan view illustrating an end portion of the first processing head unit of the laser processing head according to an eighteenth modification of the first embodiment, the end portion facing the second processing head unit.

FIG. 49 is a plan view illustrating an end portion of the first processing head unit of the laser processing head according to a nineteenth modification of the first embodiment, the end portion facing the second processing head unit.

FIG. 50 is a plan view illustrating an end portion of the first processing head unit of the laser processing head according to a twentieth modification of the first embodiment, the end portion facing the second processing head unit.

FIG. 51 is a plan view illustrating an end portion of the first processing head unit of the laser processing head according to a twenty-first modification of the first embodiment, the end portion facing the second processing head unit.

FIG. 52 is a plan view illustrating an end portion of the first processing head unit of the laser processing head according to a twenty-second modification of the first embodiment, the end portion facing the second processing head unit.

FIG. 53 is a plan view illustrating an end portion of the first processing head unit of the laser processing head according to a twenty-third modification of the first embodiment, the end portion facing the second processing head unit.

FIG. 54 is a perspective view illustrating the magnet of the laser processing head according to a twenty-fourth modification of the first embodiment.

FIG. 55 is a cross-sectional view illustrating a state in which the magnet illustrated in FIG. 54 is disposed in the first processing head unit,

FIG. 56 is a perspective view illustrating an end portion of the first processing head unit of the laser processing head according to a twenty-fifth modification of the first embodiment, the end portion facing the second processing head unit.

FIG. 57 is a perspective view illustrating the second processing head unit of the laser processing head according to a twenty-sixth modification of the first embodiment.

FIG. 58 is a perspective view illustrating the magnet and the yoke of the laser processing head according to a twenty-seventh modification of the first embodiment,

FIG. 59 is a cross-sectional view illustrating a state in which the magnet and the yoke illustrated in FIG. 58 are disposed in the first processing head unit.

FIG. 60 is a perspective view illustrating an end portion of the first processing head unit of the laser processing head according to a twenty-eighth modification of the first embodiment, the end portion facing the second processing head unit.

FIG. 61 is a perspective view illustrating the magnet and the yoke of the laser processing head according to a twenty-ninth modification of the first embodiment.

FIG. 62 is a perspective view illustrating the magnet and the yoke of the laser processing head according to a thirtieth modification of the first embodiment.

FIG. 63 is a perspective view illustrating the magnet and the yoke of the laser processing head according to a thirty-first modification of the first embodiment,

FIG. 64 is a perspective view illustrating the magnet and the yoke of the laser processing head according to a thirty-second modification of the first embodiment.

FIG. 65 is a perspective view illustrating the magnet and the yoke according to a thirty-third modification of the first embodiment.

### DESCRIPTION OF EMBODIMENTS

Hereinafter, a laser processing head and a laser processing machine according to an embodiment will be described in detail with reference to the drawings.

### First Embodiment

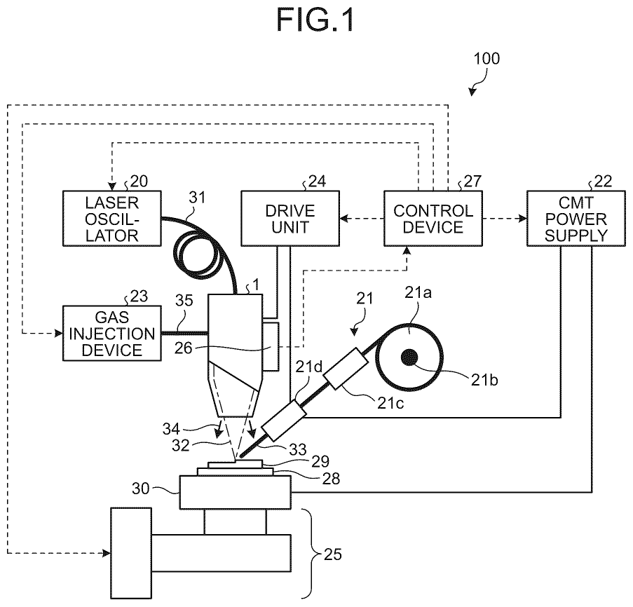

FIG. 1 is a diagram illustrating a schematic configuration of an additive manufacturing apparatus 100 according to a first embodiment. In the present embodiment, a case where a laser processing machine is the additive manufacturing apparatus 100 will be described as an example. The additive manufacturing apparatus 100 is a machine tool that manufactures a shaped object by stacking a molten material. The additive manufacturing apparatus 100 performs additive manufacturing by arc welding and beam irradiation. What is meant by the term “shaped object” used herein includes not only a finished product obtained by stacking molten materials but also materials stacked in the middle of manufacturing the finished product.

The additive manufacturing apparatus 100 feeds a wire 33 which is a material to the workpiece, and stacks beads made of the molten material on a substrate 28. The additive manufacturing apparatus 100 manufactures a shaped object 29 on the substrate 28 by stacking the beads on the substrate 28. The substrate 28 is placed on a stage 30. A workpiece is an object to which a molten material is added, and here, refers to the substrate 28 and the shaped object 29. The substrate 28 illustrated in FIG. 1 is a plate material, but may be a material other than the plate material.

The additive manufacturing apparatus 100 includes a laser oscillator 20, a laser processing head 1, a feeding mechanism 21, a cold metal transfer (CMT) power supply 22, a gas injection device 23, a drive unit 24, a rotation shaft 25, a height sensor 26, and a control device 27.

The laser oscillator 20 generates a laser beam 32. The laser beam 32 propagates to the laser processing head 1 through a fiber cable 31 which is an optical transmission line.

The laser processing head 1 irradiates the workpiece with the laser beam 32 generated by the laser oscillator 20.

The feeding mechanism 21 feeds the wire 33 to the workpiece. The feeding mechanism 21 includes a wire spool 21a, a rotary motor 21b, a wire straightener 21c, and a wire feeder 21d. The wire spool 21a is a supply source of the wire 33. The wire 33 is wound around the wire spool 21a in coil form. The rotary motor 21b rotates the wire spool 21a. The wire straightener 21c removes curling of the wire 33 fed from the wire spool 21a to straighten the wire 33. The wire feeder 21d feeds the wire 33 straightened by the wire straightener 21c to the workpiece. The rotary motor 21b performs driving for feeding the wire 33 from the wire spool 21a toward the workpiece and driving for pulling back, to the wire spool 21a, the wire 33 which has been fed out.

The CMT power supply 22 is a power supply that supplies the wire 33 with a current for heating the wire 33 to be fed to the workpiece. The CMT power supply 22 is connected to the wire feeder 21d and the stage 30, When the wire 33 and the wire feeder 21d come into contact with each other, the wire 33 and the CMT power supply 22 are electrically connected. When the substrate 28 and the stage 30 come into contact with each other, the workpiece and the CMT power supply 22 are electrically connected. The CMT power supply 22 applies a pulse voltage between the wire 33 and the workpiece.

The CMT power supply 22 generates an arc by applying a pulse voltage when the wire 33 is away from the workpiece. The CMT power supply 22 controls the current so that as compared with when the wire 33 and the workpiece are short-circuited, the current increases when the short circuit between the wire 33 and the workpiece is released. In addition, the CMT power supply 22 heats the wire 33 by applying the current to the wire 33.

The gas injection device 23 injects a gas 34 to the workpiece. The gas 34 flows from the gas injection device 23 to the laser processing head 1 through a pipe 35, and is injected from the laser processing head 1 toward the workpiece. By injection of the gas 34, the additive manufacturing apparatus 100 prevents oxidation of the shaped object 29 and cools the beads.

The drive unit 24 moves the laser processing head 1 and the wire feeder 21d. The drive unit 24 is an operation mechanism that performs translational movement in each of directions of three axes. The drive unit 24 moves a feeding position of the wire 33 in the workpiece and an irradiation position of the laser beam 32 in the workpiece.

The rotation shaft 25 rotates the stage 30. The additive manufacturing apparatus 100 can bring a posture of the workpiece into a posture suitable for machining by rotating the workpiece together with the stage 30.

The height sensor 26 is a sensor for sensing a distance in a height direction between a tip of a nozzle 3d to be described later and the workpiece during machining. A result of sensing by the height sensor 26 is sent to the control device 27.

The control device 27 controls the entirety of the additive manufacturing apparatus 100. The control device 27 controls start and stop of the drive unit 24, the rotation shaft 25, the laser oscillator 20, the rotary motor 21b, the CMT power supply 22, the gas injection device 23, and the like.

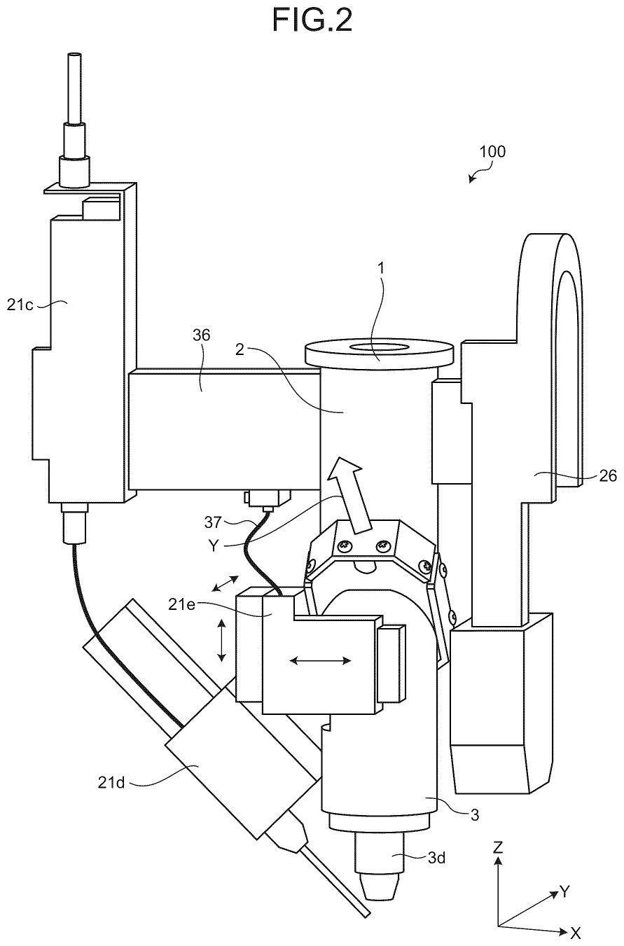

FIG. 2 is a perspective view illustrating the laser processing head 1, the wire feeder 21d, the wire straightener 21c, and the height sensor 26 in the first embodiment. Hereinafter, when directions regarding the respective components of the wire feeder 21d, the wire straightener 21c, and the height sensor 26 of the laser processing head 1 will be described, the description will be given in accordance with an X-axis direction, a Y-axis direction, and a Z-axis direction illustrated in FIG. 2. The X-axis direction, the Y-axis direction, and the Z-axis direction illustrated in the figures other than FIG. 2 correspond to the X-axis direction, the Y-axis direction, and the Z-axis direction illustrated in FIG. 2. The X-axis direction and the Y-axis direction are horizontal directions. The Z-axis direction is a vertical direction. The Z-axis direction corresponds to a first direction. In the X-axis direction, a direction indicated by an arrow in each figure may be referred to as a positive X direction, and a direction opposite to the positive X direction may be referred to as a negative X direction. In the Y-axis direction, a direction indicated by an arrow in each figure may be referred to as a positive Y direction, and a direction opposite to the positive Y direction may be referred to as a negative Y direction. In the Z-axis direction, a direction indicated by an arrow in each figure may be referred to as a positive Z direction, and a direction opposite to the positive 2 direction may be referred to as a negative Z direction. The positive Z direction is a vertically upward direction. The negative Z direction is a vertically downward direction.

As illustrated in FIG. 2, the additive manufacturing apparatus 100 further includes a support frame 36 that supports the laser processing head 1, the wire straightener 21c, the height sensor 26, and the like, and a fastening structure 37 that fastens the wire feeder 21d and the support frame 36, The wire straightener 21c is spaced from the wire feeder 21d in the Z-axis direction. The wire straightener 21c is spaced from the height sensor 26 in the X-axis direction. The wire straightener 21c is disposed on a side opposite to the height sensor 26, in the X-axis direction, of an optical path hole 1a (to be described later) of the laser processing head 1.

The wire feeder 21d is spaced from the height sensor 26 in the X-axis direction. The wire feeder 21d is fixed to a second processing head unit 3 (to be described later) of the laser processing head 1. The wire feeder 21d is separated from a first processing head unit 2 (to be described later) together with the second processing head unit 3 at a time of a collision of the laser processing head 1. The wire feeder 21d includes a position adjustment mechanism 21e for adjusting a position with respect to the second processing head unit 3. The position adjustment mechanism 21e can adjust the position of the wire feeder 21d in directions of double-headed arrows illustrated in FIG. 2, that is, in each of the X-axis direction, the Y-axis direction, and the Z-axis direction. Therefore, the position of the tip of the wire 33 can be adjusted to an appropriate position with respect to the laser beam 32 with which the second processing head unit 3 performs irradiation. The fastening structure 37 is a metal wire that connects the position adjustment mechanism 21e and the support frame 36. Even when the wire feeder 21d collides with the workpiece and is detached from the second processing head unit 3 of the laser processing head 1, the fastening structure 37 that fastens the wire feeder 21d and the support frame 36 is provided, so that the detached wire feeder 21d can avoid colliding with the laser processing head 1 and the like, and damage to the wire feeder 21d, the laser processing head 1, and the like can be reduced.

As will be described later, when the laser processing head 1 collides downward, the second processing head unit 3 slides to move in a direction of an arrow Y in FIG. 2. The wire feeder 21d is disposed on a side opposite to the height sensor 26, in the X-axis direction, of the optical path hole 1a of the laser processing head 1, Consequently, the wire feeder 21d that has slid to move together with the second processing head unit 3 can avoid colliding with the height sensor 26, and damage to the wire feeder 21d and the height sensor 26 can be reduced.

The wire straightener 21c and the height sensor 26 are disposed in a direction orthogonal to a direction of sliding movement of the second processing head unit 3. That is, the wire straightener 21c and the height sensor 26 are not disposed at a destination of the sliding movement of the second processing head unit 3. Consequently, the second processing head unit 3 that has slid to move can avoid colliding with the wire straightener 21c and the height sensor 26, and damage to the second processing head unit 3, the wire straightener 21c, and the height sensor 26 can be reduced. The wire straightener 21c and the height sensor 26 are disposed on the same XY plane. Consequently, it is possible to achieve space saving for the additive manufacturing apparatus 100 in the Y-axis direction,

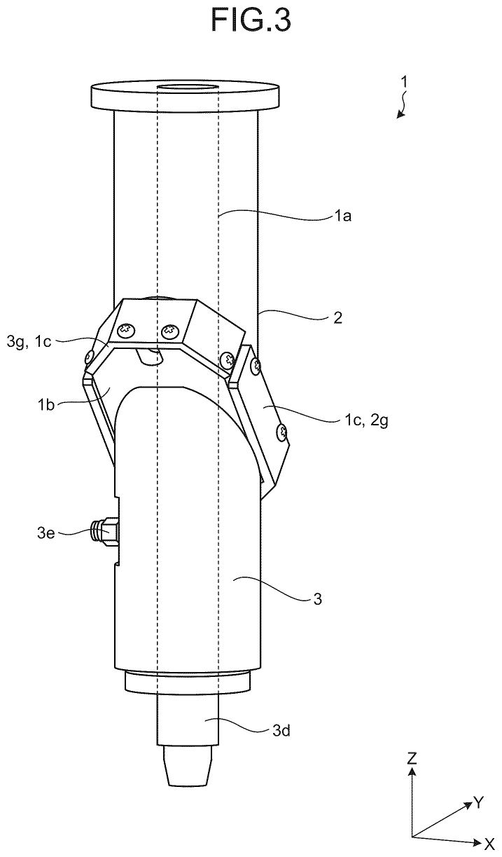

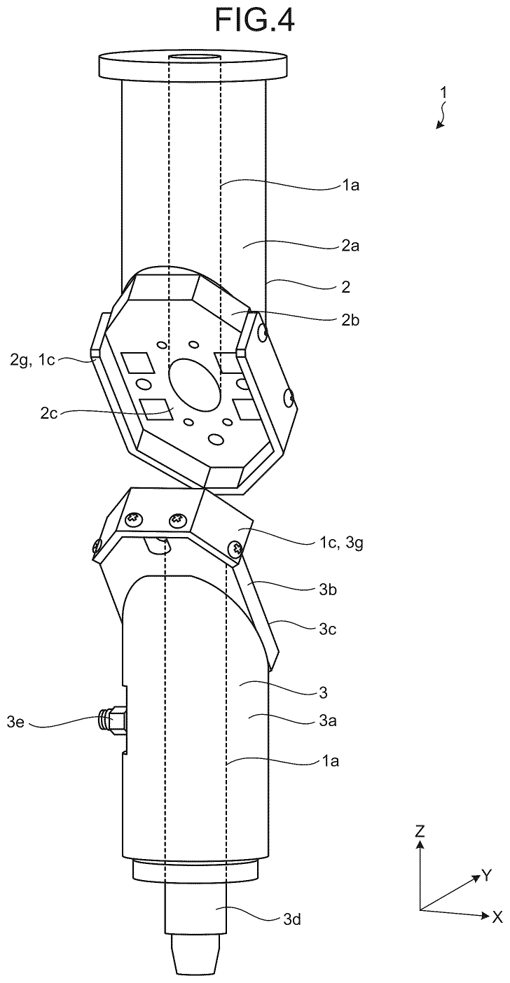

FIG. 3 is a perspective view illustrating the laser processing head 1 in the first embodiment, and is a view illustrating a state in which the first processing head unit 2 and the second processing head unit 3 are coupled. FIG. 4 is a perspective view illustrating the laser processing head 1 in the first embodiment, and is a view illustrating a state in which the first processing head unit 2 and the second processing head unit 3 are separated. As illustrated in FIGS. 3 and 4, the optical path hole 1a for passing the laser beam 32 is formed inside the laser processing head 1 and extends in the Z-axis direction. The laser processing head 1 can move in each of the X-axis direction, the Y-axis direction, and the Z-axis direction. In addition to the laser beam 32, a gas from the gas injection device 23 flows into the optical path hole 1a.

The laser processing head 1 includes the first processing head unit 2 and the second processing head unit 3 disposed side by side with the first processing head unit 2 in the Z-axis direction and coupled to the first processing head unit 2 in a separable manner. The second processing head unit 3 is disposed vertically below the first processing head unit 2. The first processing head unit 2 is a portion fixed to the drive unit 24 illustrated in FIG. 1. The second processing head unit 3 is a portion that irradiates the workpiece with the laser beam 32, and is a portion to be separated from the first processing head unit 2 at a time of a collision of the laser processing head 1 and the workpiece.

As illustrated in FIG. 4, the first processing head unit 2 includes a first main body portion 2a extending in the Z-axis direction and a first plate portion 2b mounted on an end portion of the first main body portion 2a that faces the second processing head unit 3 and having a first inclined surface 2c formed thereon. The shape of the first main body portion 2a is only required to be a cylindrical shape, and is a circular cylindrical shape in the present embodiment. The first main body portion 2a is made of metal. The metal is, for example, aluminum or stainless steel.

The first plate portion 2b constitutes an end portion of the first processing head unit 2 that faces the second processing head unit 3. The first plate portion 2b is made of a non-magnetic material. The non-magnetic material is, for example, aluminum or stainless steel.

The second processing head unit 3 includes a second main body portion 3a extending in the Z-axis direction and a second plate portion 3b mounted on an end portion of the second main body portion 3a that faces the first processing head unit 2 and having a second inclined surface 3c formed thereon. The shape of the second main body portion 3a is only required to be a cylindrical shape, and is a circular cylindrical shape in the present embodiment. The second main body portion 3a is made of metal. The metal is, for example, plated iron.

The nozzle 3d that irradiates the workpiece with the laser beam 32 is mounted on another end portion of the second main body portion 3a facing away from the first processing head unit 2. The nozzle 3d is made of metal such as copper. A cooling water joint 3e is mounted on an outer peripheral surface of the second main body portion 3a. Although not illustrated, a pipe through which cooling water flows is connected to the cooling water joint 3e, and a cooling flow path through which the cooling water flows is formed inside the second processing head unit 3. The cooling flow path communicates with the pipe via the cooling water joint 3e.

The second plate portion 3b constitutes an end portion of the second processing head unit 3 that faces the first processing head unit 2. The second plate portion 3b is made of a magnetic material,

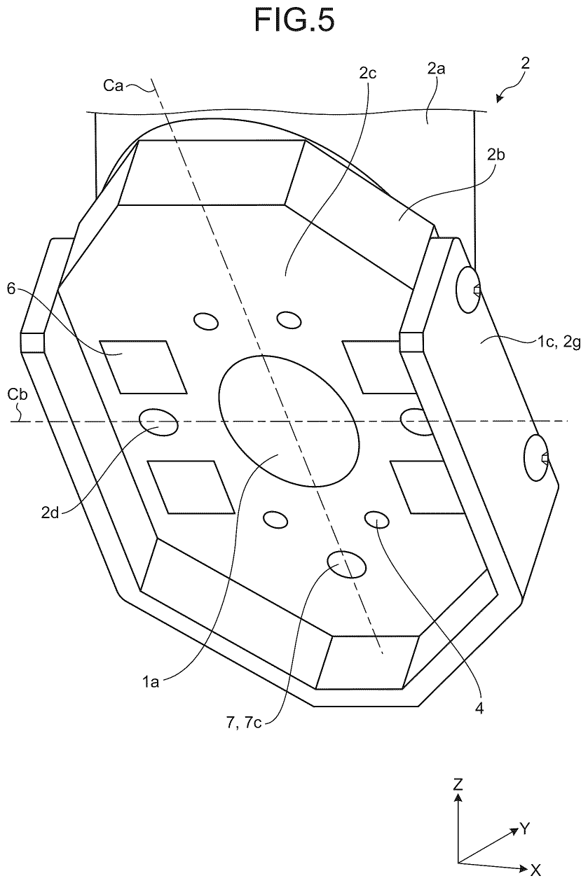

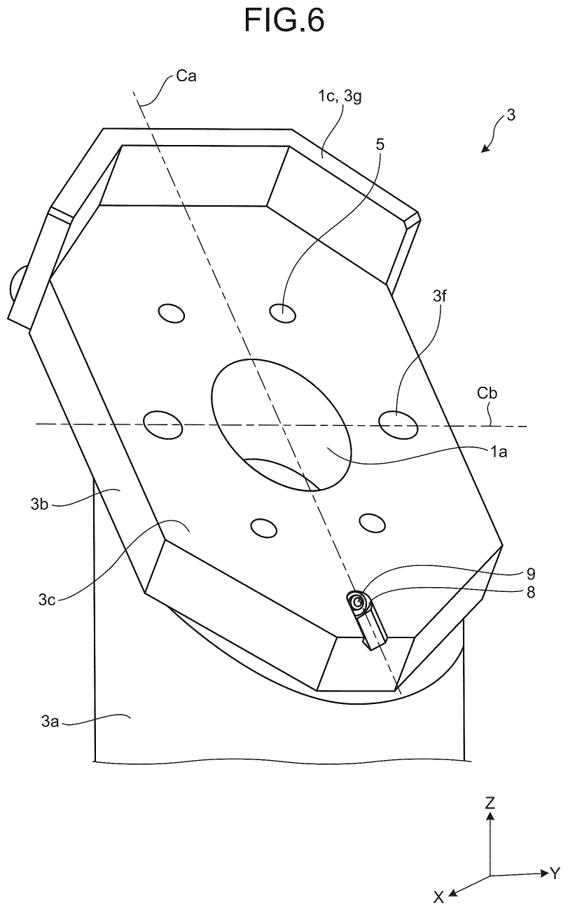

FIG. 5 is a perspective view illustrating the end portion of the first processing head unit 2 that faces the second processing head unit 3. FIG. 6 is a perspective view illustrating the end portion of the second processing head unit 3 that faces the first processing head unit 2. The shape of the first plate portion 2b illustrated in FIG. 5 and the shape of the second plate portion 3b illustrated in FIG. 6 are each an octagonal shape in the present embodiment, but may be appropriately changed.

As illustrated in FIG. 5, the first plate portion 2b is formed with the first inclined surface 2c inclined with respect to the Z-axis direction. The first inclined surface 2c is provided with a plurality of movable pins 4, a plurality of magnets 6, and a contact sensor 7. The optical path hole 1a is opened at the center of the first inclined surface 2c.

As illustrated in FIG. 6, the second plate portion 3b is formed with the second inclined surface 3c parallel to the first inclined surface 2c. The term “parallel” used herein includes not only a state of being completely parallel but also a state of being not strictly parallel but slightly inclined. The first inclined surface 2c and the second inclined surface 3c are inclined at the same angle in the same direction. The second inclined surface 3c is provided with a pin seat 5, a sensor groove 8, and a sensor abutment pin 9. The optical path hole 1a is opened at the center of the second inclined surface 3c.

Hereinafter, a direction in which the first inclined surface 2c and the second inclined surface 3c are inclined is referred to as an inclination direction. The inclination direction is a second direction.

Each magnet 6 is an attraction member that couples the first processing head unit 2 and the second processing head unit 3 in a separable manner. As the magnet 6, for example, a neodymium magnet is used,

Each movable pin 4 is a positioning pin that protrudes toward the second inclined surface 3c illustrated in FIG. 6 and is energized toward the second inclined surface 3c. The movable pin 4 can be inserted into the pin seat 5 illustrated in FIG. 6 and can be detached from the pin seat 5. The movable pin 4 is fitted into the pin seat 5 when inserted into the pin seat 5. The movable pin 4 is disposed independently at a position away from (or apart from) the magnet 6.

The contact sensor 7 is a mechanical sensor that includes a contact portion 7c in contact with the sensor abutment pin 9 illustrated in FIG. 6 and senses, by displacement of the contact portion 7c, positional deviation of the second processing head unit 3 with respect to the first processing head unit 2. The contact sensor 7 is configured such that when the position of the second processing head unit 3 with respect to the first processing head unit 2 is not deviated, the contact portion 7c comes into contact with the sensor abutment pin 9, and thereby an ON signal is transmitted to the control device 27 illustrated in FIG. 1. On the other hand, the contact sensor 7 is configured such that when the position of the second processing head unit 3 with respect to the first processing head unit 2 is deviated, the contact portion 7c is separated from the sensor abutment pin 9, and thereby an OFF signal is transmitted to the control device 27. When receiving the OFF signal, the control device 27 provides emergency stop of the movement of the laser processing head 1 and the irradiation with the laser beam 32.

The pin seat 5 is a positioning recess into which the movable pin 4 illustrated in FIG. 5 is inserted. In the present embodiment, the pin seat 5 does not have play (or room) with which the movable pin 4 inserted into the pin seat 5 can move along the inclination direction.

The sensor groove 8 is a groove that accommodates the sensor abutment pin 9. The sensor groove 8 extends along the inclination direction. An extending direction of the sensor groove 8 is parallel to the inclination direction. The shape of the sensor groove 8 is not particularly limited as long as it is a shape that enables the sensor abutment pin 9 to be accommodated and does not prevent the relative movement of the second processing head unit 3 with respect to the contact sensor 7 at the time of sliding movement of the second processing head unit 3.

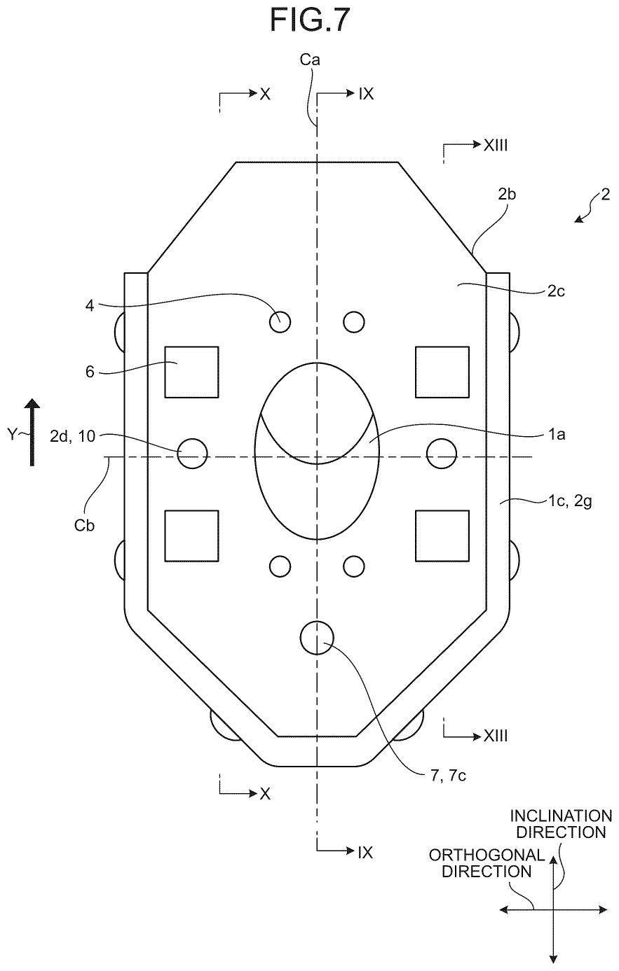

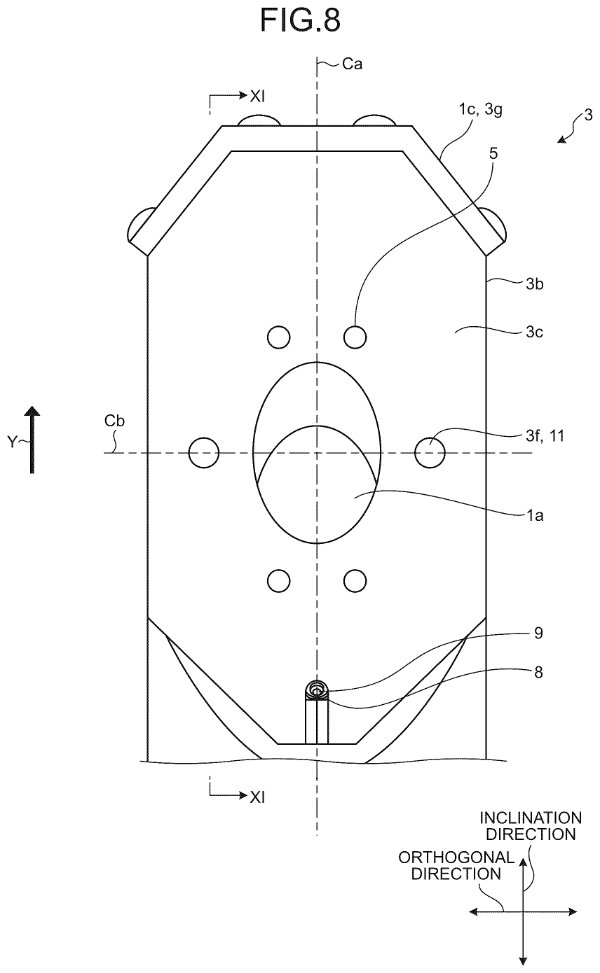

FIG. 7 is a plan view illustrating the end portion of the first processing head unit 2 that faces the second processing head unit 3. FIG. 8 is a plan view illustrating the end portion of the second processing head unit 3 that faces the first processing head unit 2. Hereinafter, a virtual straight line passing through the centers of the first inclined surface 2c and the second inclined surface 3c and along the inclination direction is defined as a first center line Ca, and a virtual straight line passing through the centers of the first inclined surface 2c and the second inclined surface 3c and along a direction orthogonal to the first center line Ca is defined as a second center line Cb. A direction orthogonal to the inclination direction in an in-plane direction of the first inclined surface 2c and the second inclined surface 3c is referred to as an orthogonal direction.

The number of movable pins 4 illustrated in FIG. 7 is four in the present embodiment. The number of movable pins 4 is only required to be at least two. If the number of movable pins 4 is at least two, it is possible to prevent the rotation of the second processing head unit 3 at the time of coupling the first processing head unit 2 and the second processing head unit 3. The four movable pins 4 are disposed to be spaced from one another in the inclination direction and the orthogonal direction. The movable pins 4 are disposed one by one in four regions defined by the first center line Ca and the second center line Cb. Regarding two movable pins 4 disposed above the second center line Cb in the inclination direction, the positions thereof in the inclination direction coincide with each other. Regarding two movable pins 4 disposed below the second center line Cb in the inclination direction, the positions thereof in the inclination direction coincide with each other. Regarding two movable pins 4 disposed on one side of the first center line Ca in the orthogonal direction, the positions thereof in the orthogonal direction coincide with each other. Regarding two movable pins 4 disposed on the other side of the first center line Ca in the orthogonal direction, the positions thereof in the orthogonal direction coincide with each other.

In order to exert an effect of positioning of the first processing head unit 2 and the second processing head unit 3 by the movable pins 4 in a well-balanced manner, it is preferable to dispose at least two movable pins 4 at different positions in the inclination direction. The movable pins 4 and the magnets 6 are provided on the same first plate portion 2b in the present embodiment. That is, the movable pins 4 and the magnets 6 are disposed only on the first inclined surface 2c in the present embodiment. Therefore, when the second processing head unit 3 slides to move, contact between the movable pins 4 and the magnets 6 can be avoided, and damage to the magnets 6 can be reduced.

The number of pin seats 5 illustrated in FIG. 8 is only required to be the same as the number of movable pins 4, and is four in the present embodiment. The pin seats 5 are disposed to be spaced from one another in the inclination direction and the orthogonal direction. The pin seats 5 are disposed one by one in four regions defined by the first center line Ca and the second center line Cb. The four pin seats 5 are disposed at the same interval as the interval at which the four movable pins 4 are disposed.

The number of magnets 6 illustrated in FIG. 7 is preferably two or more, and is four in the present embodiment. The four magnets 6 are disposed to be spaced from one another in the inclination direction and the orthogonal direction. The magnets 6 are disposed one by one in four regions defined by the first center line Ca and the second center line Cb. Regarding two magnets 6 disposed above the second center line Cb in the inclination direction, the positions thereof in the inclination direction coincide with each other. Regarding two magnets 6 disposed below the second center line Cb in the inclination direction, the positions thereof in the inclination direction coincide with each other. Regarding two magnets 6 disposed on one side of the first center line Ca in the orthogonal direction, the positions thereof in the orthogonal direction coincide with each other, Regarding two magnets 6 disposed on the other side of the first center line Ca in the orthogonal direction, the positions thereof in the orthogonal direction coincide with each other.

The magnets 6 are each disposed at a position farther from the first center line Ca and closer to the second center line Cb than the movable pins 4. The magnets 6 are each disposed at a position away from (or apart from) the movable pins 4 and the contact sensor 7 on the first inclined surface 2c. In addition, the magnets 6 are each disposed at a position away from (or apart from) the sensor abutment pin 9 of the second inclined surface 3c illustrated in FIG. 8 in a state in which the first processing head unit 2 and the second processing head unit 3 are coupled. Furthermore, the magnets 6 and the sensor abutment pin 9 are disposed not collinearly along the inclination direction. Consequently, when the second processing head unit 3 slides to move with respect to the first processing head unit 2, the magnets 6 can avoid coming into contact with the sensor abutment pin 9, and damage to the magnets 6 can be reduced.

As illustrated in FIGS. 7 and 8, the contact sensor 7 and the sensor abutment pin 9 are disposed collinearly along the inclination direction in the present embodiment.

As illustrated in FIG. 7, first insertion holes 2d each for inserting a fastening member 10 that fastens the first plate portion 2b and the first main body portion 2a are opened in the first inclined surface 2c. As illustrated in FIG. 8, second insertion holes 3f each for inserting a fastening member 11 that fastens the second plate portion 3b and the second main body portion 3a are opened in the second inclined surface 3c.

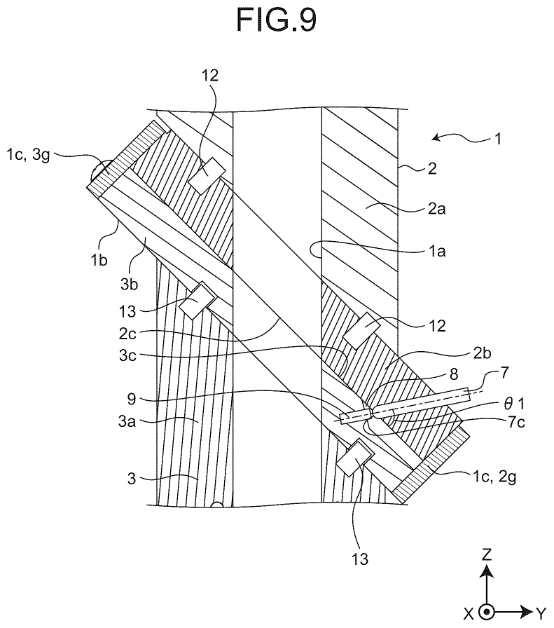

Next, the contact sensor 7 will be further described with reference to FIG. 9. FIG. 9 is a cross-sectional view taken along line IX-IX illustrated in FIG. 7. In FIG. 9, a cross section of the second processing head unit 3 is also illustrated. As illustrated in FIG. 9, the contact sensor 7 is a rod-shaped member. The contact sensor 7 is mounted through the first plate portion 2b. The tip of the contact sensor 7 is exposed from the first inclined surface 2c. The contact sensor 7 provided on the first inclined surface 2c is inclined so as to form an acute angle with the first inclined surface 2c. An angle 01 formed by the contact sensor 7 and the first inclined surface 2c is an acute angle. The contact sensor 7 is mounted on the first plate portion 2b such that the tip of the contact sensor 7 is inclined upward in the inclination direction.

The first processing head unit 2 is provided with a plurality of pins 12 for performing positioning of the first main body portion 2a and the first plate portion 2b. The second processing head unit 3 is provided with a plurality of pins 13 for performing positioning of the second main body portion 3a and the second plate portion 3b.

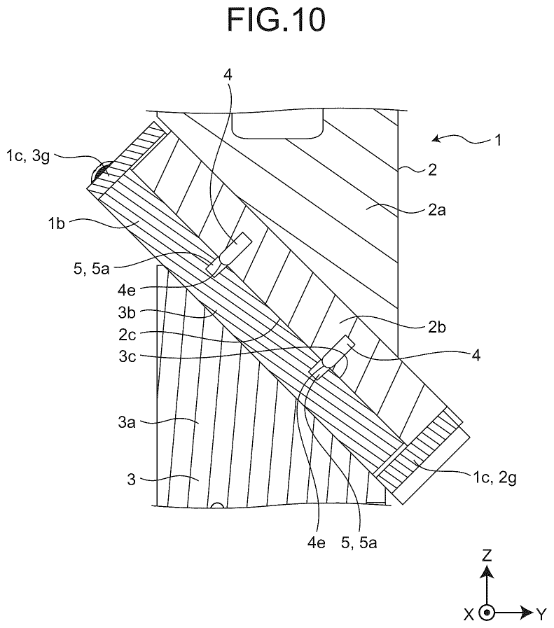

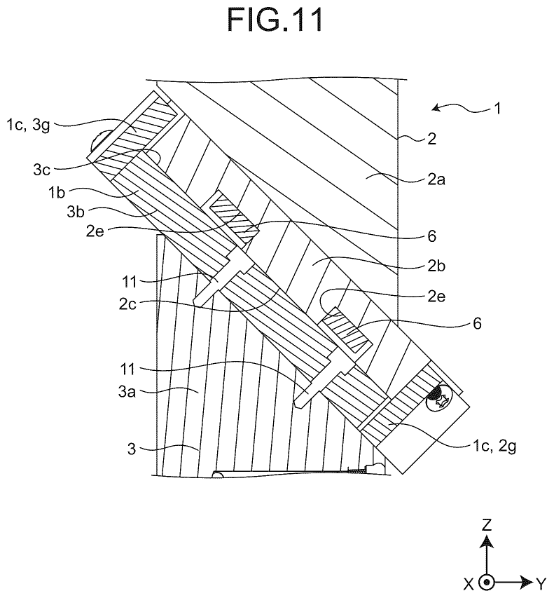

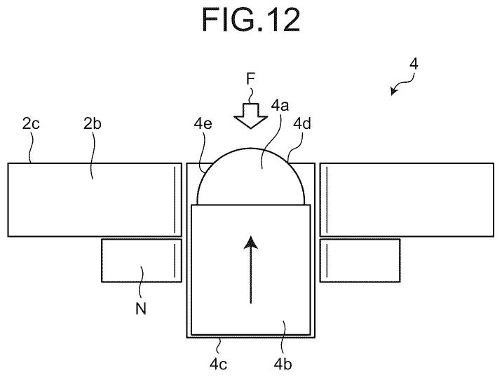

Next, the movable pin 4, the pin seat 5, and the fastening members 10 and 11 will be further described with reference to FIGS. 10 to 12. FIG. 10 is a cross-sectional view taken along line X-X illustrated in FIG. 7. FIG. 11 is a cross-sectional view taken along line XI-XI illustrated in FIG. 8. FIG. 12 is a view schematically illustrating the movable pin 4. In FIG. 10, a cross section of the second processing head unit 3 is also illustrated. In FIG. 11, a cross section of the first processing head unit 2 is also illustrated. As illustrated in FIG. 11, each fastening member 11 is screwed into the second plate portion 3b and the second main body portion 3a. The fastening member 11 is, for example, a bolt.

As illustrated in FIG. 12, the movable pin 4 includes a movable component 4a, an energizing means 4b, and a container 4c. The container 4c is a bottomed cylindrical member. The container 4c is formed with an opening 4d for allowing the movable component 4a to protrude therefrom. The movable component 4a is a member that is movable in a direction protruding from the opening 4d of the container 4c and in a direction pushed to the bottom of the container 4c. A movable pin-side contact surface 4e tapered toward the pin seat 5 is formed at a tip of the movable component 4a. The movable pin-side contact surface 4e is formed in a hemispherical shape whose diameter decreases from a proximal end side toward a distal end side of the movable component 4a. The energizing means 4b is disposed between the movable component 4a and the bottom of the container 4c, and serves to energize the movable component 4a in the direction protruding from the opening 4d of the container 4c. The energizing means 4b is, for example, an elastic body, air, or oil. The elastic body is, for example, a spring or rubber.

In the present embodiment, the movable pin 4 is an extrusion-type movable pin of which the movable component 4a is extruded in the direction protruding from the opening 4d of the container 4c. When an external force F applied to the movable pin-side contact surface 4e of the movable component 4a exceeds an energizing force of the energizing means 4b, the movable component 4a is pushed toward the bottom of the container 4c. On the other hand, when the external force F applied to the movable pin-side contact surface 4e of the movable component 4a is removed, the movable component 4a is extruded toward the opening 4d of the container 4c by the energizing force of the energizing means 4b, and the movable component 4a returns to the original shape thereof. A screw groove (not illustrated) is formed on an outer peripheral surface of the container 4c. A nut N is joined to a back surface of the first plate portion 2b by welding. By screwing the screw groove of the container 4c into the nut N, the movable pin 4 can be fixed to the first plate portion 2b. Note that a method for fixing the movable pin 4 may be, for example, a fixing method such as adhesion or press-fitting.

In the present embodiment, each pin seat 5 illustrated in FIG. 10 has a circular cylindrical shape. On an inner surface of the pin seat 5, a pin seat-side contact surface 5a with which the movable pin-side contact surface 4e is in contact is formed. The pin seat-side contact surface 5a serves to contact the movable pin 4 to restrict movement of the second processing head unit 3 along the X-axis direction and downward movement thereof in the inclination direction.

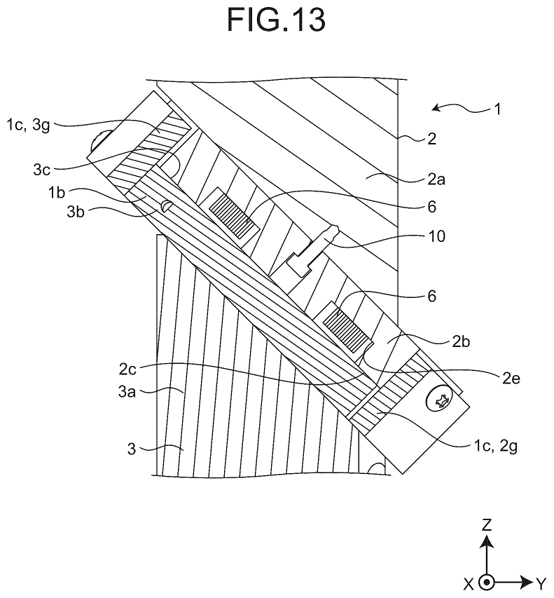

Next, the magnet 6 will be further described with reference to FIGS. 13 and 14. FIG. 13 is a cross-sectional view taken along line XIII-XIII illustrated in FIG. 7. FIG. 14 is a perspective view illustrating the magnet 6. In FIG. 13, a cross section of the second processing head unit 3 is also illustrated. As illustrated in FIG. 14, the magnet 6 has a plate shape. The magnet 6 is magnetized in a thickness direction of the magnet 6. The magnet 6 is formed with screw holes 6a penetrating the magnet 6 in the thickness direction thereof. A screw S is inserted into each screw hole 6a.

As illustrated in FIG. 13, each magnet 6 is disposed in a mounting hole 2e opened in the first inclined surface 2c. A thickness dimension of the magnet 6 is smaller than a depth dimension of the mounting hole 2e. Although not specifically illustrated in FIG. 13, the magnet 6 is fixed to the first plate portion 2b by screwing the screw S into each screw hole 6a of the magnet 6 and each screw hole of the first plate portion 2b. The magnet 6 is disposed such that the thickness direction of the magnet 6 is perpendicular to the first inclined surface 2c and the second inclined surface 3c. A surface of the magnet 6 facing the second inclined surface 3c is an attraction surface that attracts the second processing head unit 3. The magnet 6 is located on a side farther apart from the second inclined surface 3c facing the mounting hole 2e than the opening of the mounting hole 2e. That is, the attraction surface of the magnet 6 does not protrude from the opening of the mounting hole 2e and is not flush with the first inclined surface 2c. Consequently, the magnet 6 can avoid coming into contact with other components, and damage to the magnet 6 can be reduced. Note that in a case where the disposition is adjusted so that the magnet 6 is unlikely to come into contact with other components, the attraction surface of the magnet 6 may protrude from the opening of the mounting hole 2e, or the attraction surface of the magnet 6 and the first inclined surface 2c may be flush with each other. The fastening member 10 is screwed into the first plate portion 2b and the first main body portion 2a. The fastening member 10 is, for example, a bolt.

Next, a flange 1b of the laser processing head 1 will be described with reference to FIG. 9. The first plate portion 2b juts in a direction intersecting the Z-axis direction as compared with the first main body portion 2a. The second plate portion 3b juts in the direction intersecting the Z-axis direction as compared with the second main body portion 3a. Consequently, in a portion of the laser processing head 1 where the laser processing head 1 is divided into the first processing head unit 2 and the second processing head unit 3, the flange 1b that juts in the direction intersecting the Z-axis direction as compared with other portions is formed.

When an inclination angle of the flange 1b with respect to a horizontal direction is less than 20 degrees, there is a possibility that a strong impact force acts between the first processing head unit 2 and the second processing head unit 3 at the time of a downward collision of the laser processing head 1, and thus the first processing head unit 2 and the second processing head unit 3 are easily damaged. On the other hand, when the inclination angle of the flange 1b with respect to the horizontal direction exceeds 70 degrees, there is a possibility that a force required to separate the second processing head unit 3 from the first processing head unit 2 at a time of a collision of the laser processing head 1 in the positive Y direction increases, and thus the first processing head unit 2 and the second processing head unit 3 are easily damaged. Therefore, the inclination angle of the flange 1b with respect to the horizontal direction is preferably 20 degrees or more and 70 degrees or less. In order to reduce damage to the laser processing head 1 while saving space for the laser processing head 1, it is more preferable that the inclination angle of flange 1b with respect to the horizontal direction be 40 degrees or more and 50 degrees or less.

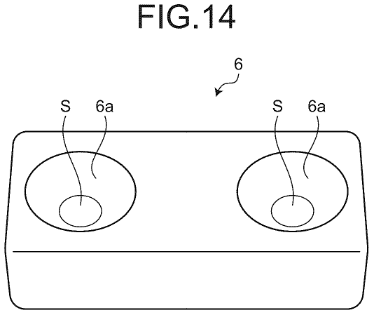

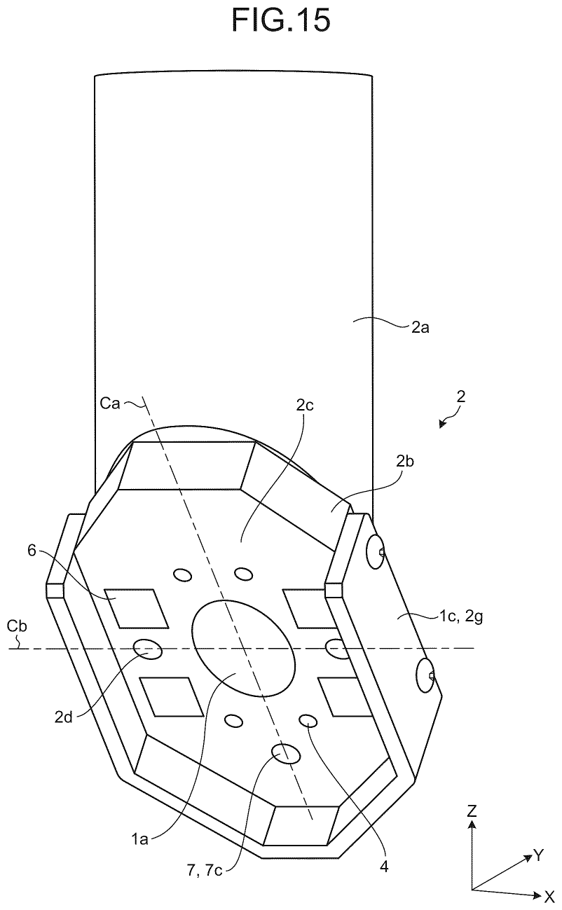

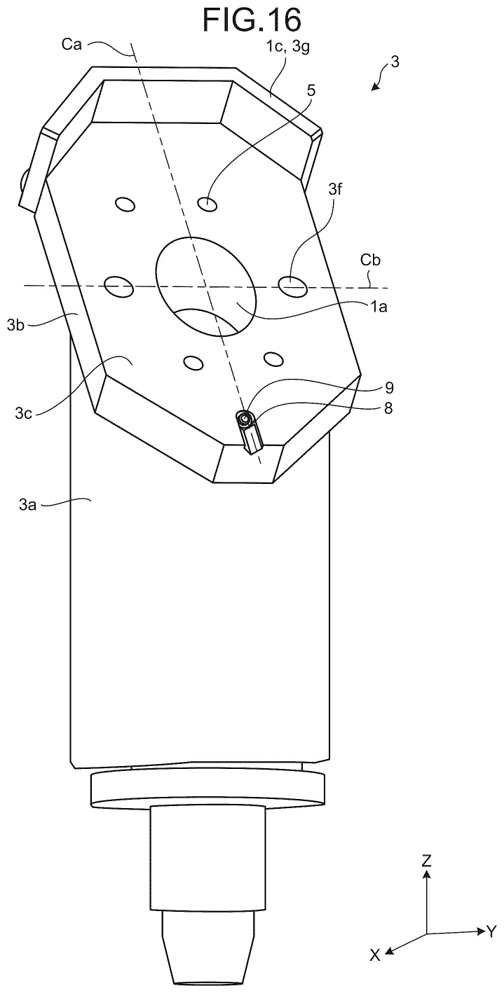

Next, a cover 1c of the laser processing head 1 will be described with reference to FIGS. 15 and 16. FIG. 15 is a perspective view illustrating the first processing head unit 2. FIG. 16 is a perspective view illustrating the second processing head unit 3. The first inclined surface 2c illustrated in FIG. 15 and the second inclined surface 3c illustrated in FIG. 16 have the same outer shape and the same outer peripheral dimension. As illustrated in FIGS. 15 and 16, the laser processing head 1 includes the cover 1c surrounding the circumferences of the first inclined surface 2c and the second inclined surface 3c. For example, rubber is used as a material for the cover 1c. The cover 1c includes a first cover 2g mounted on the first plate portion 2b illustrated in FIG. 15 and a second cover 3g mounted on the second plate portion 3b illustrated in FIG. 16,

As illustrated in FIG. 15, the first cover 2g is provided along a lower edge and side edges of the first inclined surface 2c. In the present embodiment, the first cover 2g is provided along, among eight sides of the first inclined surface 2c, five sides on a lower side in the inclination direction. As illustrated in FIG. 16, the second cover 3g is provided along an upper edge of the second inclined surface 3c. In the present embodiment, the second cover 3g is provided along, among eight sides of the second inclined surface 3c, three sides on an upper side in the inclination direction. When the first processing head unit 2 and the second processing head unit 3 are coupled to each other, the first cover 2g and the second cover 3g surround the circumferences of the first inclined surface 2c and the second inclined surface 3c.

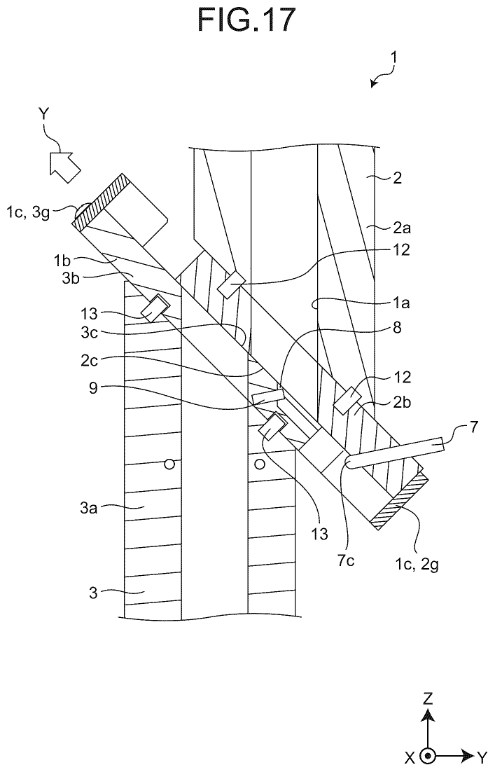

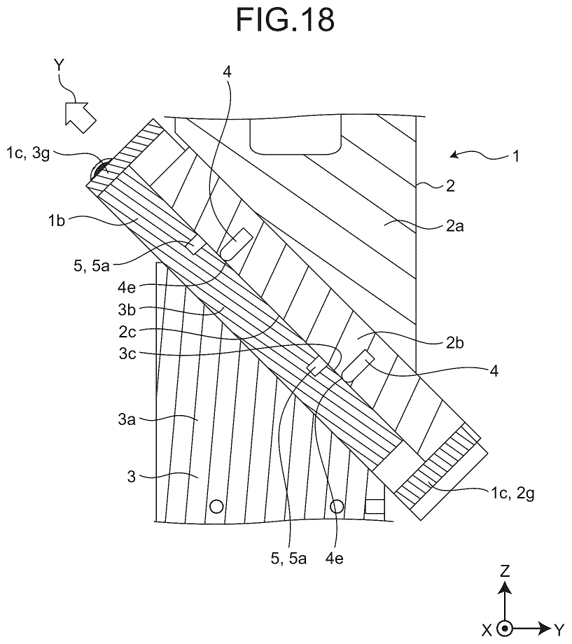

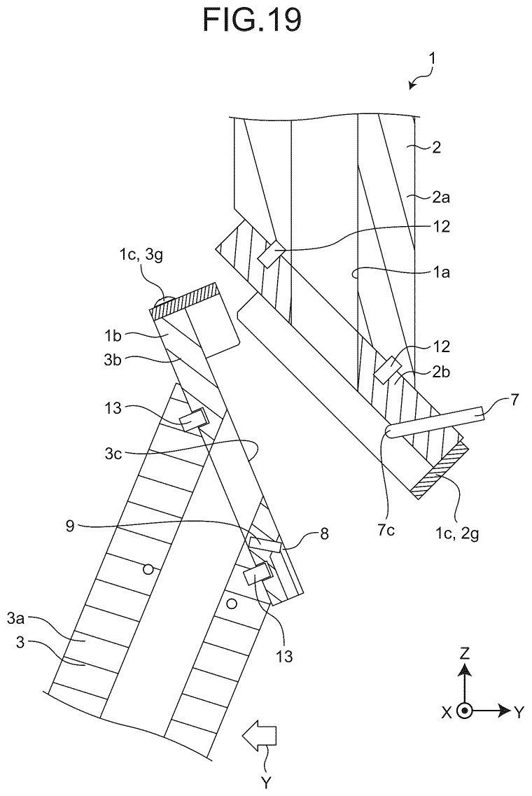

Next, with reference to FIGS. 9, 10, and 17 to 20, an operation of the laser processing head 1 according to the present embodiment at a time of a collision thereof will be described. FIG. 17 is a cross-sectional view illustrating a state of the laser processing head 1 at a time of a downward collision thereof, and is a view corresponding to the cross-sectional view taken along line IX-IX illustrated in FIG. 7. FIG. 18 is a cross-sectional view illustrating a state of the laser processing head 1 at the time of the downward collision thereof, and is a view corresponding to the cross-sectional view taken along line X-X illustrated in FIG. 7. FIG. 19 is a cross-sectional view illustrating a state of the laser processing head 1 at a time of a collision thereof in the Y-axis direction, and is a view corresponding to the cross-sectional view taken along line IX-IX illustrated in FIG. 7. FIG. 20 is a perspective view illustrating a state of the laser processing head 1 at a time of a collision thereof in the X-axis direction. An arrow Y illustrated in each of FIGS. 17 to 20 indicates a direction of movement of the second processing head unit 3 at the time of the collision.

First, a description will be given for a case of a downward collision which is a case where the laser processing head 1 collides with a workpiece while moving vertically downward. As illustrated in FIG. 9, in a normal state before the laser processing head 1 collides with the workpiece, the first processing head unit 2 and the second processing head unit 3 are coupled to each other by an attraction force of the magnets 6. The contact sensor 7 is in contact with the sensor abutment pin 9. As illustrated in FIG. 10, the movable pins 4 are each extruded toward the second inclined surface 3c and fitted into the pin seat 5, and thereby the movement of the second processing head unit 3 in the X-axis direction and the downward movement thereof in the inclination direction are restricted.

When the second processing head unit 3 collides with the workpiece while the laser processing head 1 illustrated in FIG. 9 is moving vertically downward and an impact force exceeding the attraction force of the magnets 6 is applied to the second processing head unit 3, the second processing head unit 3 slides to move upward in the inclination direction as illustrated in FIG. 17. At that time, as illustrated in FIG. 18, the movable components 4a are each separated from the pin seat 5, so that the sliding movement of the second processing head unit 3 is not prevented.

As illustrated in FIG. 17, by the sensor abutment pin 9 moving upward in the inclination direction relative to the contact sensor 7, the contact portion 7c is separated from the sensor abutment pin 9, and an OFF signal is transmitted to the control device 27 illustrated in FIG. 1. The control device 27 that has received the OFF signal provides emergency stop of the movement of the laser processing head 1 and the irradiation with the laser beam 32.

Next, with reference to FIG. 19, a description will be given for a case of a horizontal collision which is a case where the laser processing head 1 collides with a workpiece while moving in the Y-axis direction. When the second processing head unit 3 collides with the workpiece while the laser processing head 1 is moving in a positive Y direction in the Y-axis direction and an impact force exceeding the attraction force of the magnets 6 is applied to the second processing head unit 3, the second processing head unit 3 rotates in an acting direction of the impact force and is separated from the first processing head unit 2. At that time, although not illustrated, the movable components 4a are each separated from the pin seat 5, so that the rotation of the second processing head unit 3 is not prevented.

The sensor abutment pin 9 is separated from the contact sensor 7, and thus the contact portion 7c is separated from the sensor abutment pin 9, so that an OFF signal is transmitted to the control device 27. The control device 27 that has received the OFF signal provides emergency stop of the movement of the laser processing head 1 and the irradiation with the laser beam 32.

Note that also in a case where the second processing head unit 3 collides with the workpiece while the laser processing head 1 is moving in a negative Y direction in the Y-axis direction and an impact force exceeding the attraction force of the magnets 6 is applied to the second processing head unit 3, an operation therein is similar to that in the above-described case where the collision with the workpiece occurs while the laser processing head 1 is moving in the positive Y direction in the Y-axis direction. Also in a case illustrated in FIG. 20 where the second processing head unit 3 collides with the workpiece while the laser processing head 1 is moving in the negative X direction in the X-axis direction and while the laser processing head 1 is moving in the positive X direction in the X-axis direction and an impact force exceeding the attraction force of the magnets 6 is applied to the second processing head unit 3, an operation therein is similar to that in the above-described case where the collision with the workpiece occurs while the laser processing head 1 is moving in the positive Y direction in the Y-axis direction.

Next, an effect of the laser processing head 1 according to the present embodiment will be described.

In the present embodiment described above, as illustrated in FIG. 13, the first inclined surface 2c is provided with the magnets 6 that couple the first processing head unit 2 and the second processing head unit 3 in a separable manner. Consequently, when the second processing head unit 3 collides with the workpiece and an impact force exceeding the attraction force of the magnets 6 is applied to the second processing head unit 3, the first processing head unit 2 and the second processing head unit 3 are separated. Specifically, when the second processing head unit 3 collides with the workpiece while the laser processing head 1 is moving vertically downward, the second processing head unit 3 slides to move upward in the inclination direction and is separated from the first processing head unit 2. When the second processing head unit 3 collides with the workpiece while the laser processing head 1 is moving in the horizontal direction, the second processing head unit 3 rotates in the acting direction of the impact force and is separated from the first processing head unit 2. Therefore, an excessive impact force is not applied to the laser processing head 1, and damage to the laser processing head 1 can be prevented.

In the present embodiment, as illustrated in FIG. 10, the first inclined surface 2c is provided with the movable pins 4 protruding toward the second inclined surface 3c and energized toward the second inclined surface 3c, and the second inclined surface 3c is provided with the pin seats 5 into which the movable pins 4 are inserted. Consequently, when the laser processing head 1 collides with the workpiece and applies an external force to the movable pins 4, and thus the movable pins 4 are pushed against the energizing force, the movable pins 4 are retracted and come out of the pin seats 5. Therefore, the movable pins 4 do not prevent the sliding movement and rotation of the second processing head unit 3. On the other hand, when the first processing head unit 2 and the second processing head unit 3 are coupled, the movable pins 4 are inserted into the pin seats 5. Consequently, a positional relationship between the first processing head unit 2 and the second processing head unit 3 is accurately determined, so that it is possible to obtain the laser processing head 1 with high positioning accuracy at the time of coupling the first processing head unit 2 and the second processing head unit 3. Therefore, even when the first processing head unit 2 and the second processing head unit 3 are once separated at the time of collision of the laser processing head 1 and then recoupled, deviation in the positional relationship between the first processing head unit 2 and the second processing head unit 3 does not occur between before separation and after recoupling of the first processing head unit 2 and the second processing head unit 3. When such a laser processing head 1 is used in a laser processing machine, it is possible to prevent occurrence of optical axis deviation of the laser beam 32 between before separation and after recoupling of the first processing head unit 2 and the second processing head unit 3. Therefore, it is possible to obtain a laser processing machine of which processing quality does not change before separation and after recoupling of the first processing head unit 2 and the second processing head unit 3.

Since the movable pins 4 are inserted into the pin seats 5 at the time of coupling the first processing head unit 2 and the second processing head unit 3, it is possible to prevent deviation of the second processing head unit 3 from the first processing head unit 2 when the laser processing head 1 performs an operation such as sudden acceleration or sudden stop.

As illustrated in FIG. 2, the wire feeder 21d is fixed to the second processing head unit 3, and the positioning accuracy at the time of coupling of the first processing head unit 2 and the second processing head unit 3 is high, so that deviation in the positional relationship between the tip of the wire feeder 21d and the nozzle 3d of the second processing head unit 3 does not occur between before separation and after recoupling of the first processing head unit 2 and the second processing head unit 3. Therefore, adjustment work of aligning the tip of the wire feeder 21d and the nozzle 3d of the second processing head unit 3 can be omitted.

In the present embodiment, as illustrated in FIG. 7, the movable pins 4 are disposed at positions away from (or apart from) the magnets 6, so that contact between the magnets 6 and the movable pins 4 can be avoided, and damage to the magnets 6 can be reduced. In particular, in the present embodiment, the movable pins 4 and the magnets 6 are disposed only on the first inclined surface 2c, so that when the second processing head unit 3 slides to move, contact between the movable pins 4 and the magnets 6 can be avoided and damage to the magnets 6 can be reduced. As illustrated in FIG. 11, the magnets 6 are each located on a side farther apart from the second inclined surface 3c facing the mounting hole 2e than the opening of the mounting hole 2e, so that the magnets 6 can avoid coming into contact with other components and damage to the magnets 6 can be reduced.

In the present embodiment, as illustrated in FIG. 12, the movable pin 4 includes the container 4c in a bottomed cylindrical shape having the opening 4d formed therein, the movable component 4a that is movable in a direction protruding from the opening 4d of the container 4c and in a direction pushed to the bottom of the container 4c, and the energizing means 4b that energizes the movable component 4a in the direction protruding from the opening 4d of the container 4c. Consequently, by adjusting the energizing force of the energizing means 4b, it is possible to achieve, in a well-balanced manner, both of the prevention of the deviation in the positional relationship at the time of coupling the first processing head unit 2 and the second processing head unit 3 and the separation of the first processing head unit 2 and the second processing head unit 3 at the time of collision of the laser processing head 1.

In the present embodiment, as illustrated in FIGS. 11 and 12, the movable pin-side contact surface 4e tapered toward the pin seat 5 is formed on the movable pin 4. Consequently, the movable pin-side contact surface 4e of the movable pin 4 comes into contact with the inner surface of the pin seat 5, and thus the movement of the movable pin 4 in the X-axis direction and the downward movement thereof in the inclination direction are restricted, so that the positions of the movable pin 4 and the pin seat 5 are uniquely determined.

In the present embodiment, as illustrated in FIG. 9, the second inclined surface 3c is provided with the sensor abutment pin 9, and the first inclined surface 2c is provided with the contact sensor 7 that includes the contact portion 7c in contact with the sensor abutment pin 9 and senses, by displacement of the contact portion 7c, positional deviation of the second processing head unit 3 with respect to the first processing head unit 2. Consequently, when the contact sensor 7 senses the positional deviation of the second processing head unit 3, the control device 27 illustrated in FIG. 1 can quickly stop the movement of the laser processing head 1 and the irradiation with the laser beam 32.

In the present embodiment, as illustrated in FIG. 9, the contact sensor 7 provided on the first inclined surface 2c is inclined so as to form an acute angle with the second inclined surface 3c. Consequently, when the second processing head unit 3 slides to move upward in the inclination direction at the time of the downward collision of the laser processing head 1, it is possible to prevent the contact sensor 7 and the sensor abutment pin 9 from rubbing against each other, and to prevent wear of both thereof.

In the present embodiment, as illustrated in FIG. 9, the second inclined surface 3c is provided with the sensor groove 8 for accommodating the sensor abutment pin 9, and the sensor groove 8 extends along the inclination direction. Consequently, when the second processing head unit 3 slides to move at the time of the downward collision of the laser processing head 1, the contact sensor 7 moves relative to the sensor groove 8 along the sensor groove 8, so that interference between the contact sensor 7 and the second inclined surface 3c can be prevented.

In the present embodiment, as illustrated in FIG. 9, the first plate portion 2b juts in the direction intersecting the Z-axis direction as compared with the first main body portion 2a, and the second plate portion 3b juts in the direction intersecting the Z-axis direction as compared with the second main body portion 3a. Consequently, portions of the laser processing head 1 other than the first plate portion 2b and the second plate portion 3b can be thinned to reduce the weight of the laser processing head 1.

During the high-speed movement of the laser processing head 1 illustrated in FIG. 13, moment of rotation is applied to the second processing head unit 3, and this moment of rotation needs to be reduced by the attraction force of the magnets 6. If the attraction force of the magnets 6 is increased, the force required for separating the first processing head unit 2 and the second processing head unit 3 at the time of collision of the laser processing head 1 increases. Therefore, the first processing head unit 2 and the second processing head unit 3 are easily deformed, which leads to more frequent replacement of the first processing head unit 2 and the second processing head unit 3. In this regard, in the present embodiment, the first plate portion 2b juts in the direction intersecting the Z-axis direction as compared with the first main body portion 2a, and the second plate portion 3b juts in the direction intersecting the Z-axis direction as compared with the second main body portion 3a, and thereby the areas of the first inclined surface 2c and the second inclined surface 3c are increased. When the areas of the first inclined surface 2c and the second inclined surface 3c are increased, an acting distance of the moment of rotation acting on the magnets 6 increases, so that the moment of rotation acting on the magnets 6 can be reduced. Consequently, an increase in the attraction force of the magnets 6 can be prevented, and thus a force for separating the first processing head unit 2 and the second processing head unit 3 at the time of collision of the laser processing head 1 can be reduced. Therefore, the first processing head unit 2 and the second processing head unit 3 are not easily deformed, and the frequency of the replacement of the first processing head unit 2 and the second processing head unit 3 can be reduced.

In the present embodiment, as illustrated in FIG. 9, when the first processing head unit 2 and the second processing head unit 3 are coupled to each other, the first cover 2g and the second cover 3g surround the circumferences of the first inclined surface 2c and the second inclined surface 3c. Consequently, it is possible to prevent an object from being caught between the first processing head unit 2 and the second processing head unit 3. As illustrated in FIGS. 15 and 16, the first cover 2g is not provided on the upper edge of the first processing head unit 2, so that interference between the second processing head unit 3 and the first cover 2g can be prevented when the second processing head unit 3 slides to move upward in the inclination direction at the time of the downward collision of the laser processing head 1, Therefore, even in a case where the first cover 2g and the second cover 3g are provided, the movement of the second processing head unit 3 is not prevented.

Next, modifications of the first embodiment will be described.

In the present embodiment, as illustrated in FIG. 5, the movable pins 4 are provided on the first inclined surface 2c, but the movable pins 4 are only required to be provided on at least one of the first inclined surface 2c or the second inclined surface 3c. Similarly, the pin seats 5 are only required to be provided on at least the other of the first inclined surface 2c or the second inclined surface 3c.

In the present embodiment, as illustrated in FIG. 5, the magnets 6 which are attraction members are provided only on the first inclined surface 2c, but the magnets 6 are only required to be provided on at least one of the first inclined surface 2c or the second inclined surface 3c. In a case where the magnets 6 are provided on both the first inclined surface 2c and the second inclined surface 3c, it is only required that portions of the first plate portion 2b and the second plate portion 3b respectively facing the magnets 6 on the second plate portion 3b and the first plate portion 2b be non-magnetic materials. Since the magnets 6 are components susceptible to an impact force at the time of collision of the laser processing head 1 and easily damaged, the magnets 6 are preferably provided only on the first inclined surface 2c of the first processing head unit 2 that does not move or rotate at the time of collision of the laser processing head 1.

In the present embodiment, as illustrated in FIG. 5, the movable pins 4 and the magnets 6 are provided only on the first inclined surface 2c, but the movable pins 4 and the magnets 6 may be disposed only on the second inclined surface 3c.

In the present embodiment, as illustrated in FIG. 9, the laser processing head 1 includes the flange 1b, but may not include the flange 1b. That is, the thickness of the laser processing head 1 may be constant over the entire length thereof in the Z-axis direction.

In the present embodiment, as illustrated in FIG. 9, the first processing head unit 2 is constituted with two members of the first main body portion 2a and the first plate portion 2b, but the first processing head unit 2 may be constituted with a single member in which the first main body portion 2a and the first plate portion 2b are integrally formed. In addition, in the present embodiment, the second processing head unit 3 is constituted with two members of the second main body portion 3a and the second plate portion 3b, but the second processing head unit 3 may be constituted with a single member in which the second main body portion 3a and the second plate portion 3b are integrally formed.

In the present embodiment, as illustrated in FIG. 9, the laser processing head 1 includes the cover 1c, but may not include the cover 1c.

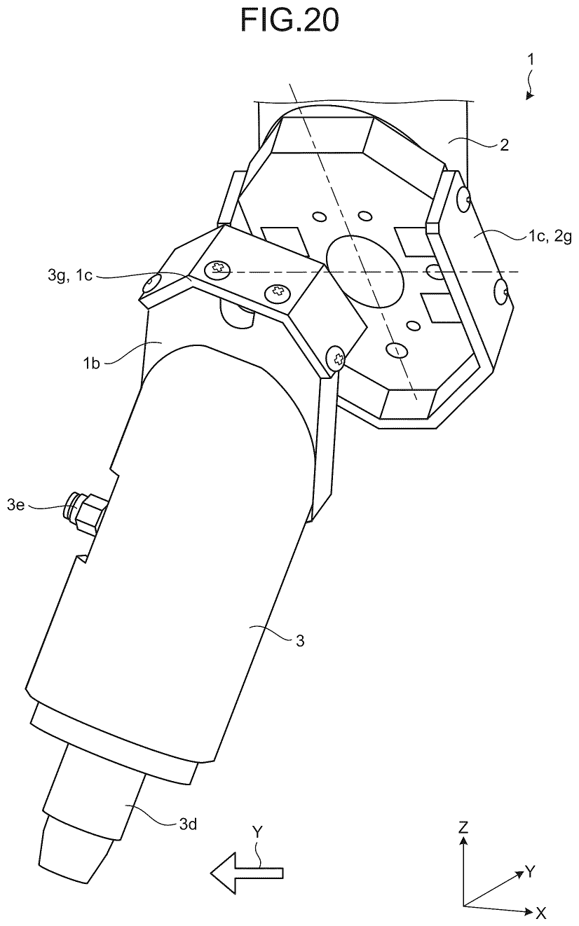

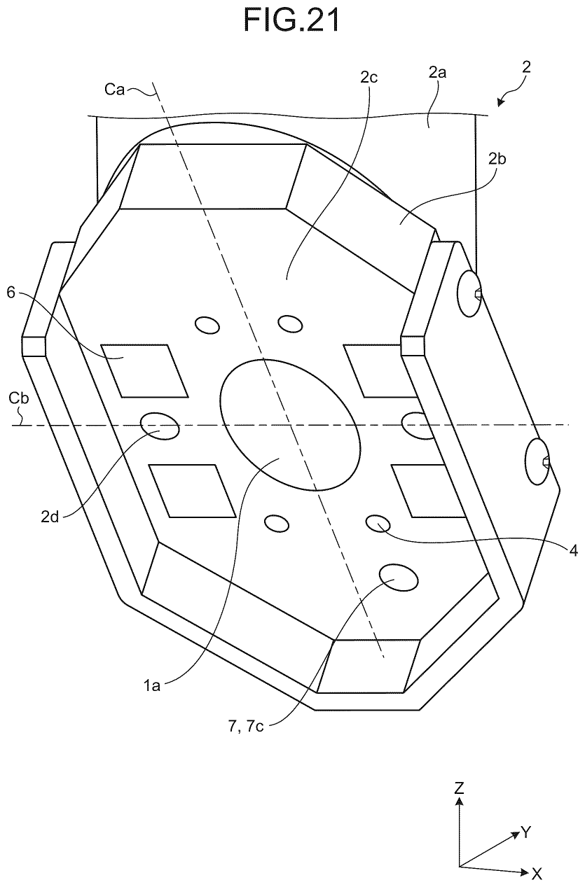

The disposition of the contact sensor 7 and the sensor abutment pin 9 is not limited to that in the illustrated example, and may be appropriately changed. For example, the disposition of the contact sensor 7 and the sensor abutment pin 9 may be disposition as illustrated in FIGS. 21 and 22. FIG. 21 is a perspective view illustrating an end portion of the first processing head unit 2 of the laser processing head 1 according to a first modification of the first embodiment, the end portion facing the second processing head unit 3. FIG. 22 is a perspective view illustrating an end portion of the second processing head unit 3 of the laser processing head 1 according to the first modification of the first embodiment, the end portion facing the first processing head unit 2. The contact sensor 7 and the sensor abutment pin 9 illustrated in FIGS. 21 and 22 are disposed at positions offset from the first center line Ca in the orthogonal direction.

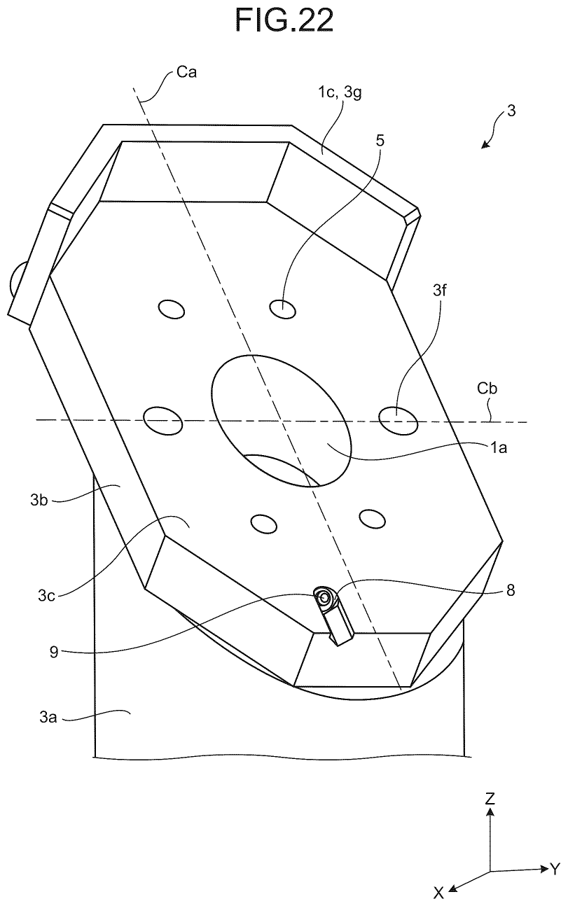

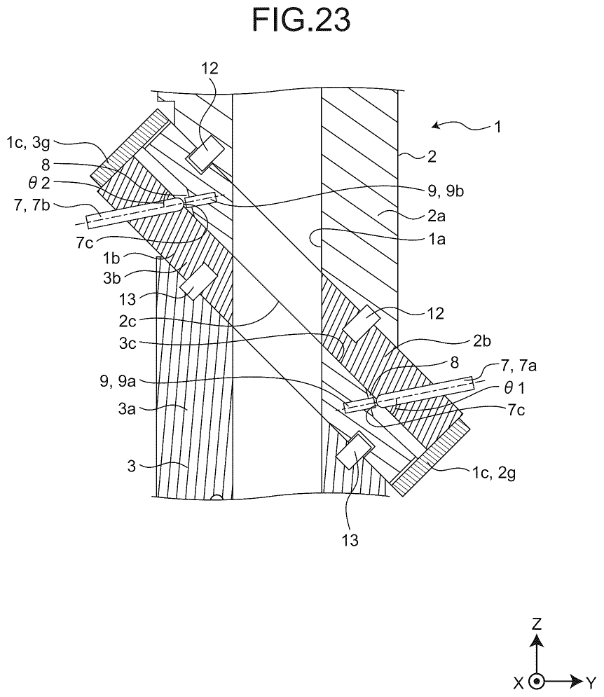

For example, the disposition of the contact sensor 7 and the sensor abutment pin 9 may be the disposition as illustrated in FIG. 23. FIG. 23 is a cross-sectional view illustrating the laser processing head 1 according to a second modification of the first embodiment, and is a view corresponding to the cross-sectional view taken along line IX-IX illustrated in FIG. 7. In the present modification, two contact sensors 7 and two sensor abutment pins 9 are provided. Each of the first plate portion 2b and the second plate portion 3b is provided with one contact sensor 7 and one sensor abutment pin 9. The two contact sensors 7 are spaced from each other in the inclination direction. The two sensor abutment pins 9 are also spaced from each other in the inclination direction. Hereinafter, in a case where the two contact sensors 7 are distinguished from each other, the contact sensors 7 are referred to as a contact sensor 7a and a contact sensor 7b. In a case where the two sensor abutment pins 9 are distinguished from each other, the sensor abutment pins 9 are referred to as a sensor abutment pin 9a and a sensor abutment pin 9b. The contact sensor 7a is mounted on the first plate portion 2b and is located below the optical path hole 1a in the inclination direction. The sensor abutment pin 9a is provided on the second inclined surface 3c and is located below the optical path hole 1a in the inclination direction. The contact sensor 7a and the sensor abutment pin 9a have configurations similar to those of the contact sensor 7 and the sensor abutment pin 9 of the first embodiment described above.

The contact sensor 7b is mounted on the second plate portion 3b and is located above the optical path hole 1a in the inclination direction. The contact sensor 7b is mounted through the second plate portion 3b. The tip of the contact sensor 7b is exposed from the second inclined surface 3c. The contact sensor 7b provided on the second inclined surface 3c is inclined so as to form an acute angle with the second inclined surface 3c. An angle θ2 formed by the contact sensor 7b and the second inclined surface 3c is an acute angle. The contact sensor 7b is mounted on the second plate portion 3b such that the tip of the contact sensor 7b is inclined downward in the inclination direction. The contact sensor 7b provided on the second inclined surface 3c is inclined so as to form an acute angle with the second inclined surface 3c, so that when the second processing head unit 3 slides to move upward in the inclination direction at the time of the downward collision of the laser processing head 1, it is possible to prevent the contact sensor 7b and the sensor abutment pin 9b from rubbing against each other, and to prevent wear of both thereof.

The sensor abutment pin 9b is provided on the first inclined surface 2c. The sensor groove 8 extends along the inclination direction. The dimension of the sensor groove 8 along the inclination direction is preferably larger than the thickness dimension of the tip of the contact sensor 7b so as not to prevent the sliding movement of the second processing head unit 3 at the time of the downward collision of the laser processing head 1. The sensor groove 8 is preferably cut to the upper edge of the first inclined surface 2c.

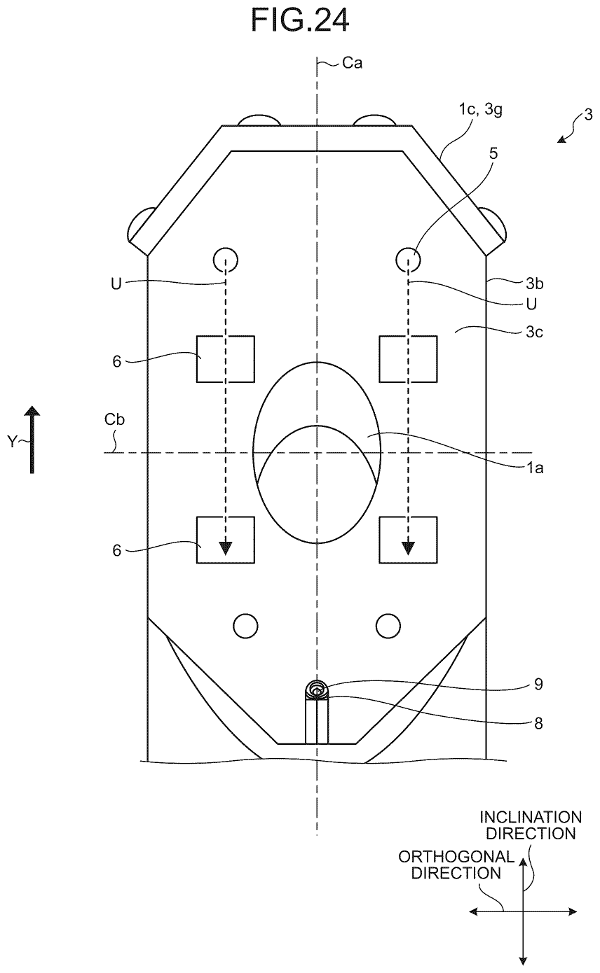

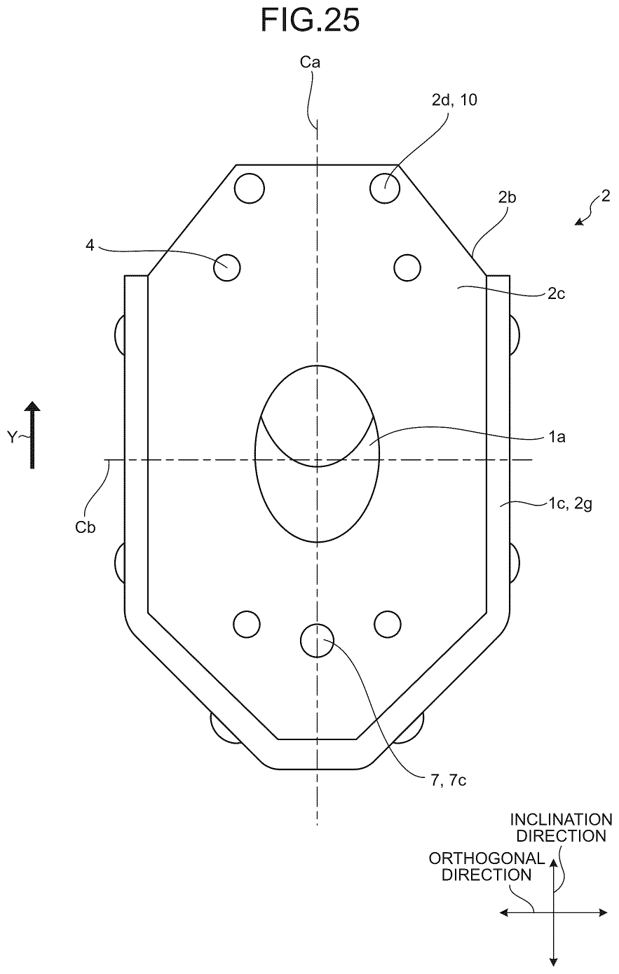

The disposition of the movable pins 4 and the magnets 6 is not limited to that in the illustrated example, and may be appropriately changed. For example, the disposition of the movable pins 4 and the magnets 6 may be disposition as illustrated in FIGS. 24 and 25. FIG. 24 is a plan view illustrating an end portion of the second processing head unit 3 of the laser processing head 1 according to a third modification of the first embodiment, the end portion facing the first processing head unit 2. FIG. 25 is a plan view illustrating an end portion of the first processing head unit 2 of the laser processing head 1 according to the third modification of the first embodiment, the end portion facing the second processing head unit 3. Each arrow U illustrated in FIG. 24 indicates a direction of movement of the movable pin 4 that moves relative to the second processing head unit 3 when the second processing head unit 3 slides to move upward in the inclination direction. The magnets 6 illustrated in FIG. 24 are provided on the second inclined surface 3c. The movable pins 4 illustrated in FIG. 25 are provided on the first inclined surface 2c. That is, the movable pins 4 and the magnets 6 are provided on different plate portions. The movable pins 4 and the magnets 6 are disposed collinearly along the inclination direction of the first inclined surface 2c and the second inclined surface 3c.

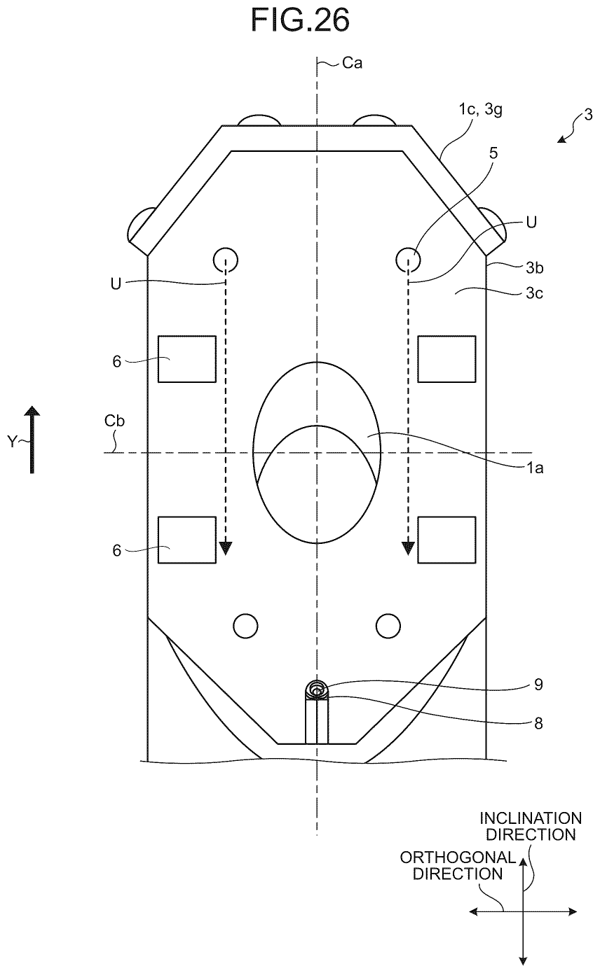

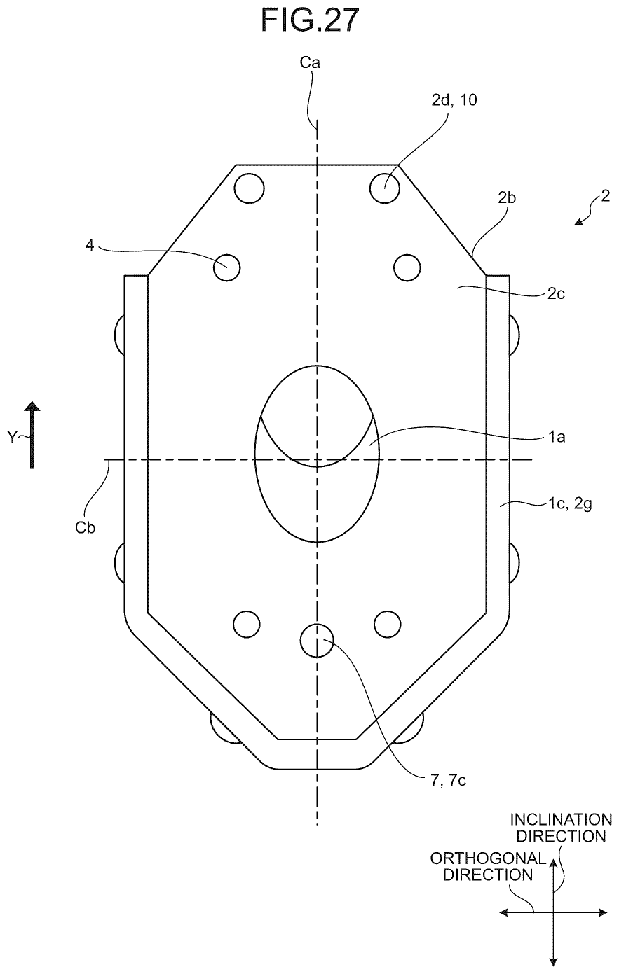

For example, the disposition of the movable pins 4 and the magnets 6 may be disposition as illustrated in FIGS. 26 and 27. FIG. 26 is a plan view illustrating an end portion of the second processing head unit 3 of the laser processing head 1 according to a fourth modification of the first embodiment, the end portion facing the first processing head unit 2. FIG. 27 is a plan view illustrating an end portion of the first processing head unit 2 of the laser processing head 1 according to the fourth modification of the first embodiment, the end portion facing the second processing head unit 3. Each arrow U illustrated in FIG. 26 indicates a direction of movement of the movable pin 4 located above the magnet 6 in the inclination direction among the movable pins 4 that move relative to the second processing head unit 3 when the second processing head unit 3 slides to move upward in the inclination direction. The magnets 6 illustrated in FIG. 26 are provided on the second inclined surface 3c. The movable pins 4 illustrated in FIG. 27 are provided on the first inclined surface 2c. That is, the movable pins 4 and the magnets 6 are provided on different plate portions. The movable pins 4 and the magnets 6 are disposed not collinearly along the inclination direction of the first inclined surface 2c and the second inclined surface 3c. Thus, when the second processing head unit 3 slides to move with respect to the first processing head unit 2, contact between the movable pins 4 and the magnets 6 can be avoided, and damage to the magnets 6 can be reduced,

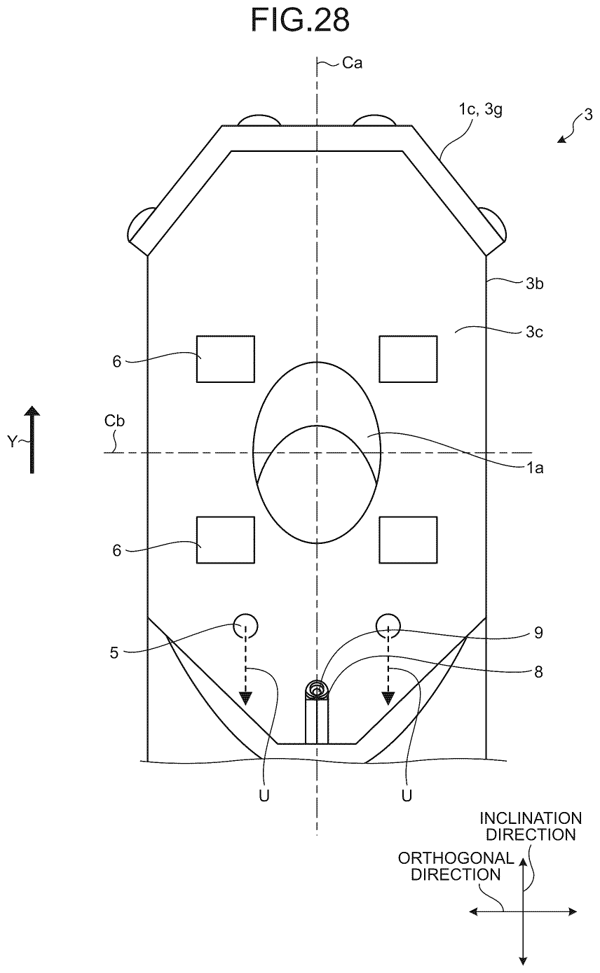

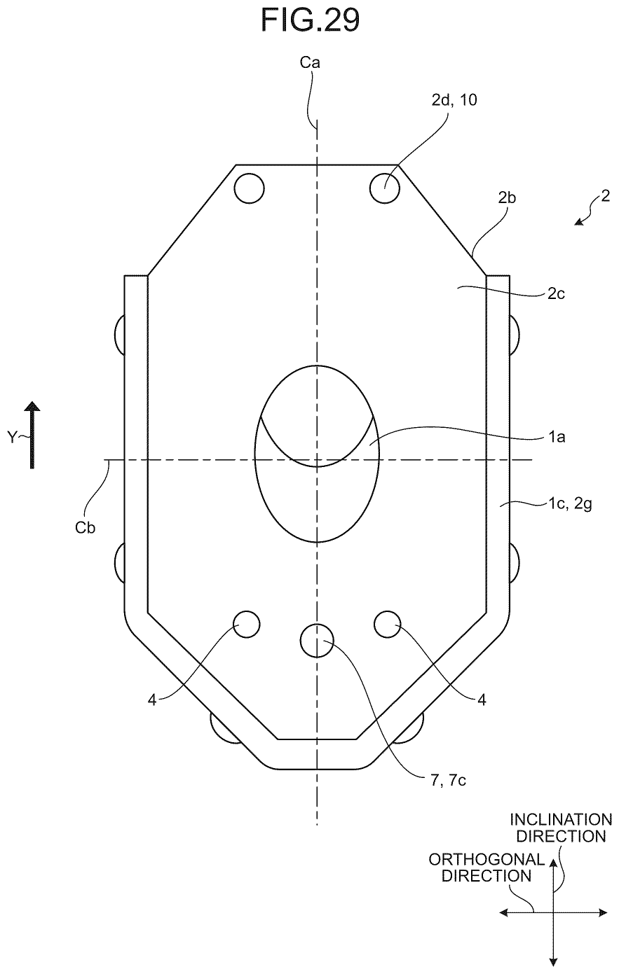

For example, the disposition of the movable pins 4 and the magnets 6 may be disposition as illustrated in FIGS. 28 and 29. FIG. 28 is a plan view illustrating an end portion of the second processing head unit 3 of the laser processing head 1 according to a fifth modification of the first embodiment, the end portion facing the first processing head unit 2. FIG. 29 is a plan view illustrating an end portion of the first processing head unit 2 of the laser processing head 1 according to the fifth modification of the first embodiment, the end portion facing the second processing head unit 3. Each arrow U illustrated in FIG. 28 indicates a direction of movement of the movable pin 4 that moves relative to the second processing head unit 3 when the second processing head unit 3 slides to move upward in the inclination direction. The magnets 6 illustrated in FIG. 28 are provided on the second inclined surface 3c. The movable pins 4 illustrated in FIG. 29 are provided on the first inclined surface 2c. That is, the movable pins 4 and the magnets 6 are provided on different plate portions. Each magnet 6 is disposed above the movable pin 4 in the inclination direction of the first inclined surface 2c and the second inclined surface 3c. Thus, when the second processing head unit 3 slides to move with respect to the first processing head unit 2, contact between the movable pins 4 and the magnets 6 can be avoided, and damage to the magnets 6 can be reduced.

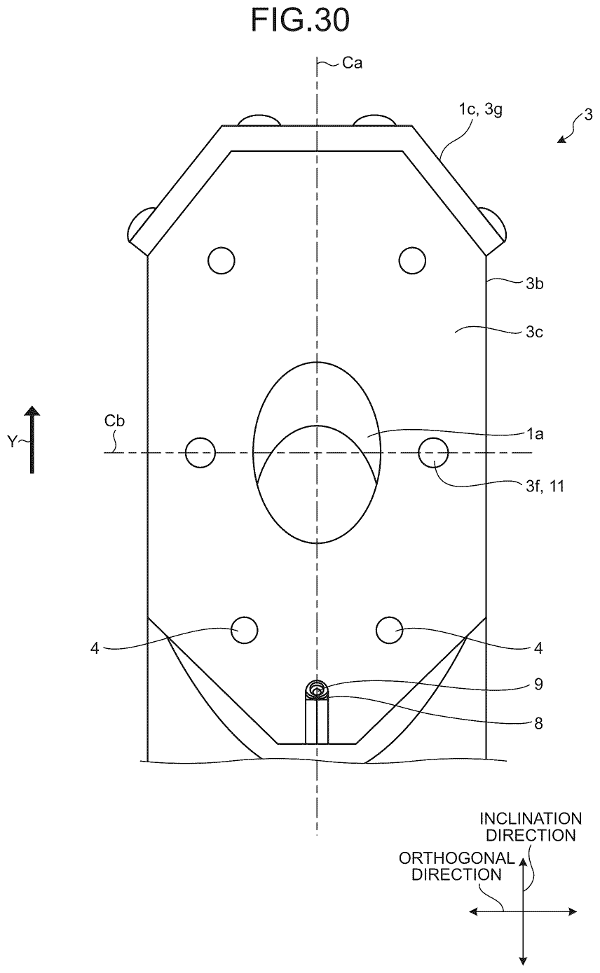

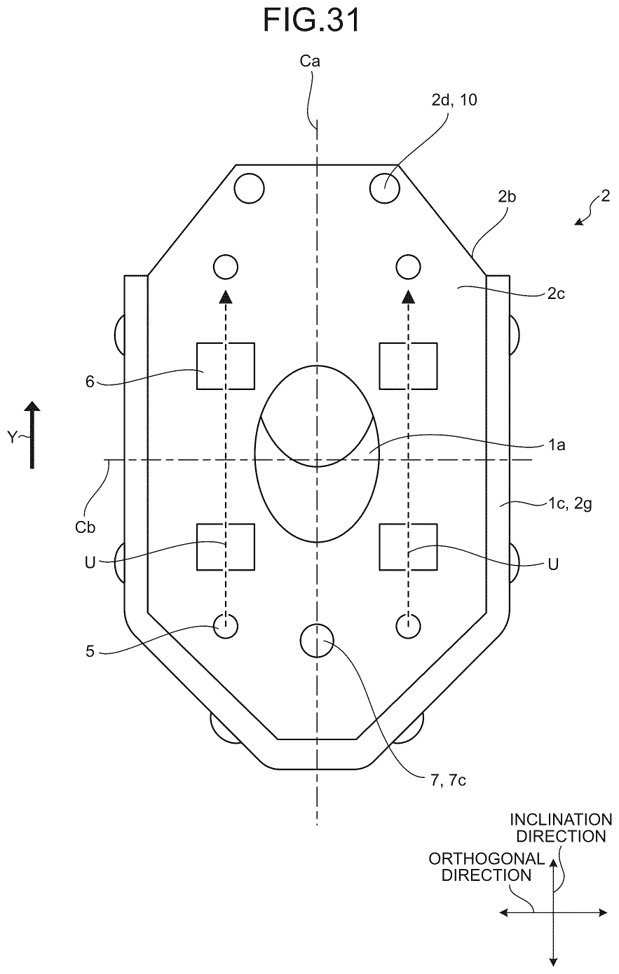

For example, the disposition of the movable pins 4 and the magnets 6 may be disposition as illustrated in FIGS. 30 and 31. FIG. 30 is a plan view illustrating an end portion of the second processing head unit 3 of the laser processing head 1 according to a sixth modification of the first embodiment, the end portion facing the first processing head unit 2. FIG. 31 is a plan view illustrating an end portion of the first processing head unit 2 of the laser processing head 1 according to the sixth modification of the first embodiment, the end portion facing the second processing head unit 3. Each arrow U illustrated in FIG. 31 indicates a direction of movement of the movable pin 4 that moves relative to the first processing head unit 2 when the second processing head unit 3 slides to move upward in the inclination direction. The magnets 6 illustrated in FIG. 31 are provided on the first inclined surface 2c. The movable pins 4 illustrated in FIG. 30 are provided on the second inclined surface 3c. That is, the movable pins 4 and the magnets 6 are provided on different plate portions. The movable pins 4 and the magnets 6 are disposed collinearly along the inclination direction of the first inclined surface 2c and the second inclined surface 3c.

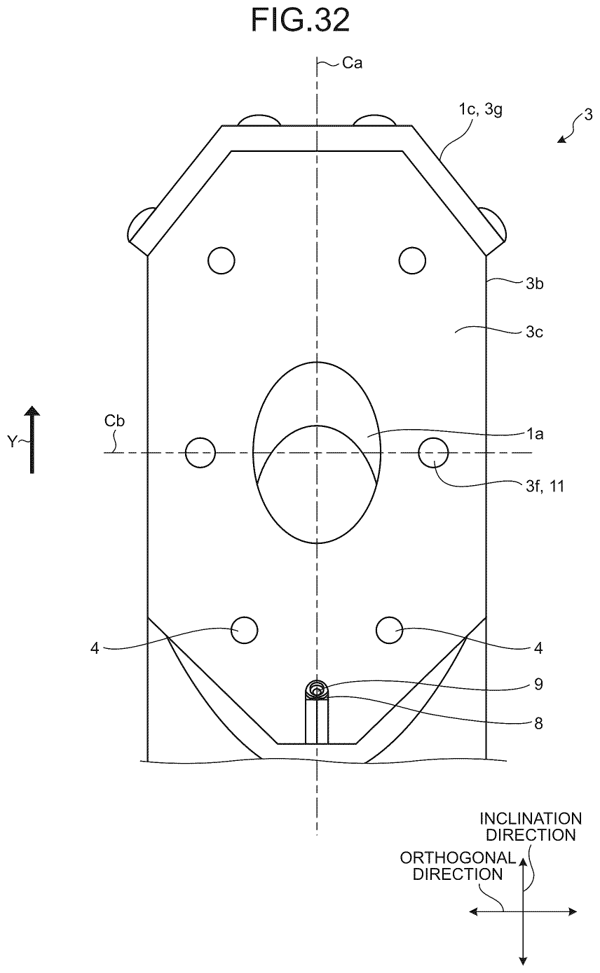

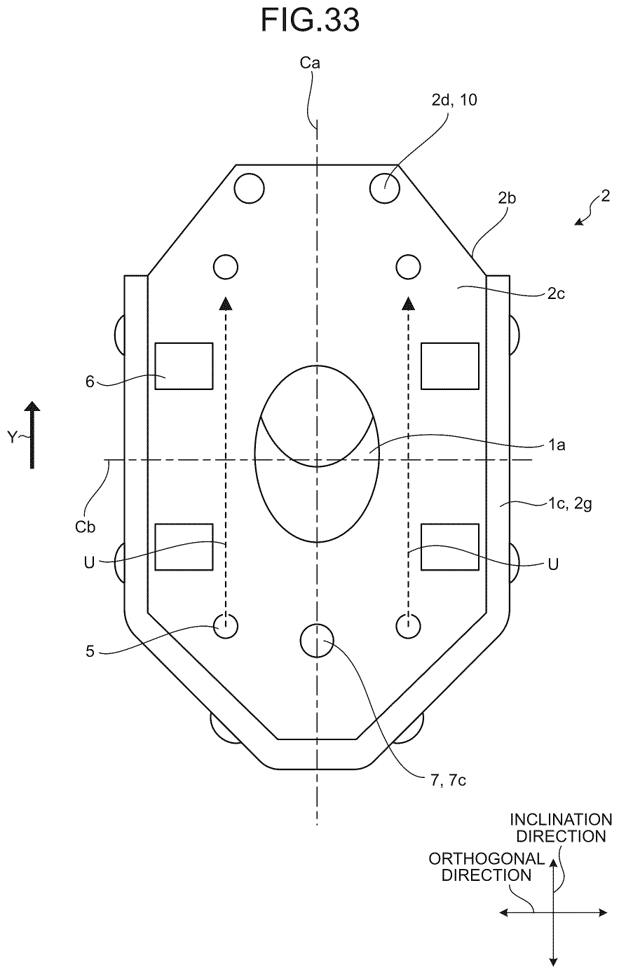

For example, the disposition of the movable pins 4 and the magnets 6 may be disposition as illustrated in FIGS. 32 and 33. FIG. 32 is a plan view illustrating an end portion of the second processing head unit 3 of the laser processing head 1 according to a seventh modification of the first embodiment, the end portion facing the first processing head unit 2. FIG. 33 is a plan view illustrating an end portion of the first processing head unit 2 of the laser processing head 1 according to the seventh modification of the first embodiment, the end portion facing the second processing head unit 3. Each arrow U illustrated in FIG. 33 indicates a direction of movement of the movable pin 4 located below the magnet 6 in the inclination direction among the movable pins 4 that move relative to the first processing head unit 2 when the second processing head unit 3 slides to move upward in the inclination direction. The magnets 6 illustrated in FIG. 33 are provided on the first inclined surface 2c. The movable pins 4 illustrated in FIG. 32 are provided on the second inclined surface 3c. That is, the movable pins 4 and the magnets 6 are provided on different plate portions. The movable pins 4 and the magnets 6 are disposed not collinearly along the inclination direction of the first inclined surface 2c and the second inclined surface 3c. Thus, when the second processing head unit 3 slides to move with respect to the first processing head unit 2, contact between the movable pins 4 and the magnets 6 can be avoided, and damage to the magnets 6 can be reduced. Note that the movable pins 4 located below the magnets 6 in the inclination direction and the magnets 6 are only required to be disposed not collinearly at least along the inclination direction of the first inclined surface 2c and the second inclined surface 3c,

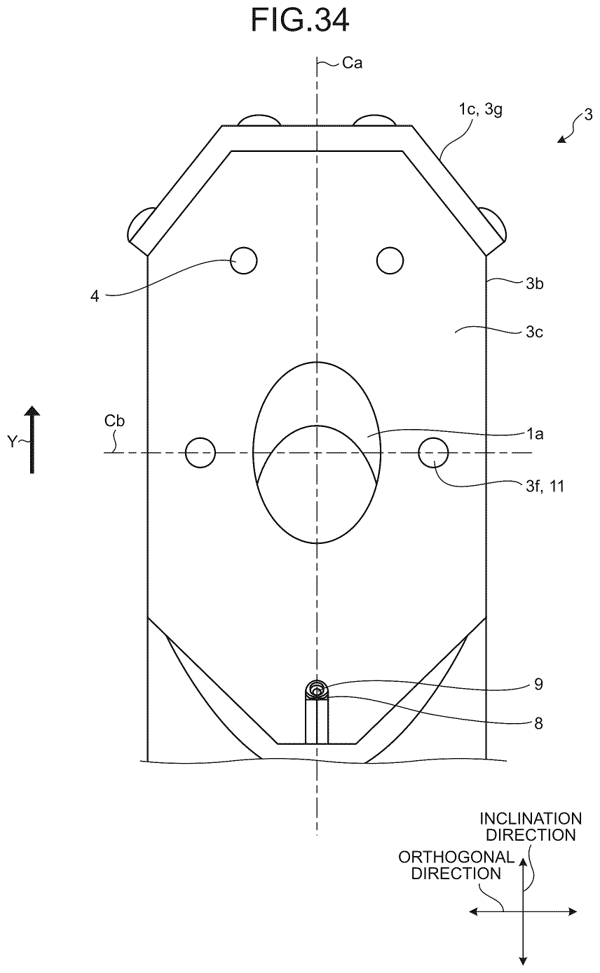

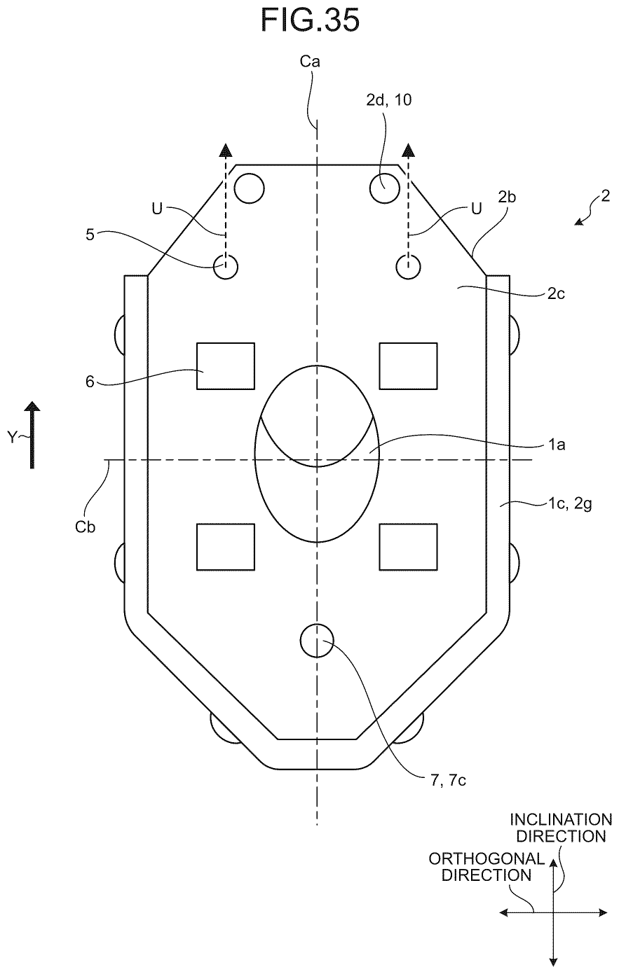

For example, the disposition of the movable pins 4 and the magnets 6 may be disposition as illustrated in FIGS. 34 and 35. FIG. 34 is a plan view illustrating an end portion of the second processing head unit 3 of the laser processing head 1 according to an eighth modification of the first embodiment, the end portion facing the first processing head unit 2. FIG. 35 is a plan view illustrating an end portion of the first processing head unit 2 of the laser processing head 1 according to the eighth modification of the first embodiment, the end portion facing the second processing head unit 3. Each arrow U illustrated in FIG. 35 indicates a direction of movement of the movable pin 4 that moves relative to the first processing head unit 2 when the second processing head unit 3 slides to move upward in the inclination direction. The magnets 6 illustrated in FIG. 35 are provided on the first inclined surface 2c. The movable pins 4 illustrated in FIG. 34 are provided on the second inclined surface 3c. That is, the movable pins 4 and the magnets 6 are provided on different plate portions. The movable pins 4 and the magnets 6 are disposed collinearly along the inclination direction of the first inclined surface 2c and the second inclined surface 3c, All movable pins 4 are disposed above the magnets 6 in the inclination direction. Thus, when the second processing head unit 3 slides to move with respect to the first processing head unit 2, contact between the movable pins 4 and the magnets 6 can be avoided, and damage to the magnets 6 can be reduced.

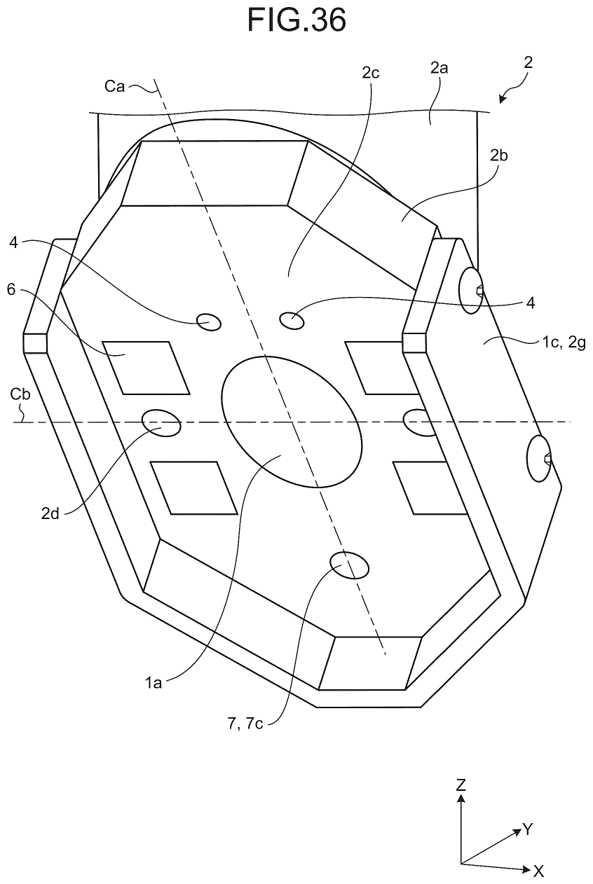

For example, the disposition of the movable pins 4 may be disposition as illustrated in FIG. 36. FIG. 36 is a perspective view illustrating an end portion of the first processing head unit 2 of the laser processing head 1 according to a ninth modification of the first embodiment, the end portion facing the second processing head unit 3. The number of movable pins 4 illustrated in FIG. 36 is two. The two movable pins 4 are provided above the portion of the first inclined surface 2c where the optical path hole 1a is opened in the inclination direction. The movable pins 4 are disposed one by one at positions offset from the first center line Ca on one side and the other side of the first center line Ca in the orthogonal direction.

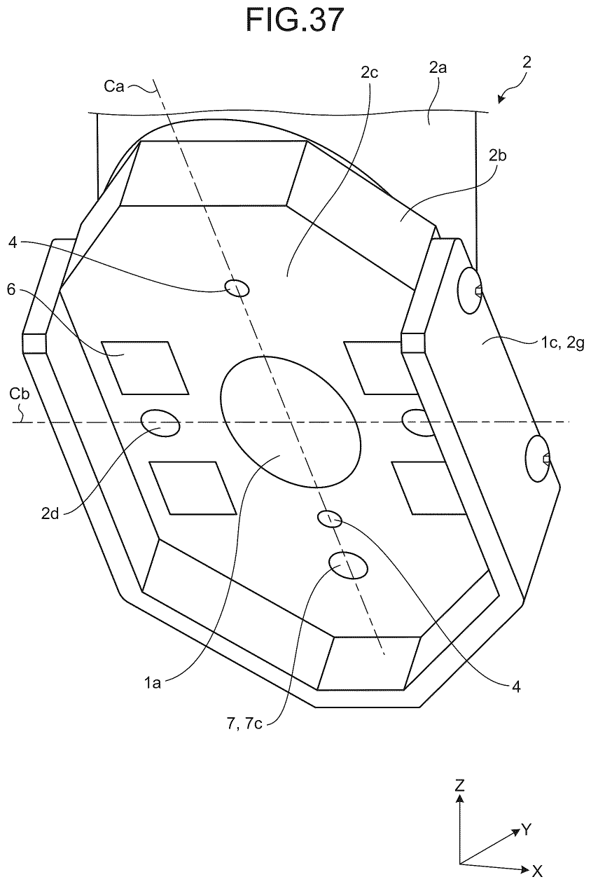

For example, the disposition of the movable pins 4 may be disposition as illustrated in FIG. 37. FIG. 37 is a perspective view illustrating an end portion of the first processing head unit 2 of the laser processing head 1 according to a tenth modification of the first embodiment, the end portion facing the second processing head unit 3. The number of movable pins 4 illustrated in FIG. 37 is two. The two movable pins 4 are disposed collinearly along the inclination direction. The two movable pins 4 are disposed on the first center line Ca in the present modification. The movable pins 4 are provided one by one above and below the portion of the first inclined surface 2c where the optical path hole 1a is opened in the inclination direction.

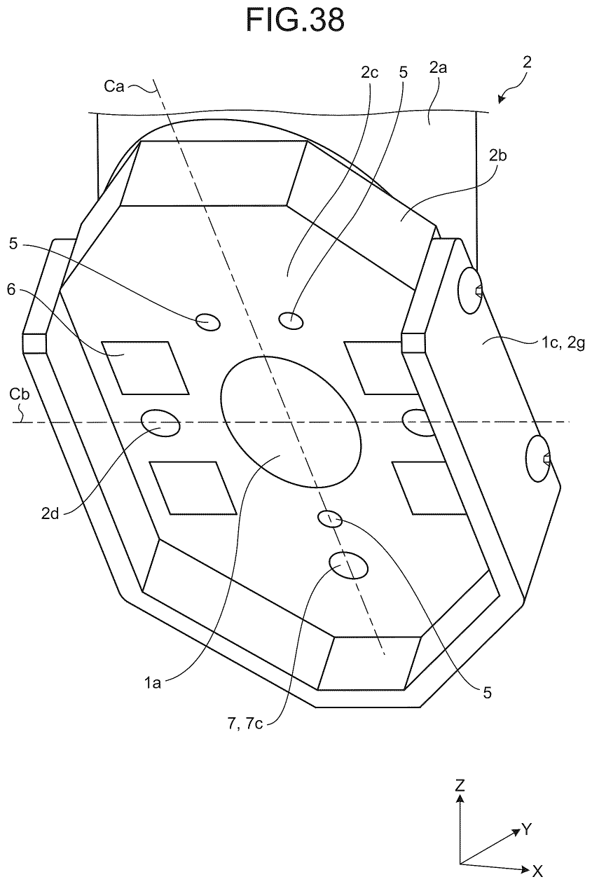

For example, the disposition of the movable pins 4 may be disposition as illustrated in FIGS. 38 and 39. FIG. 38 is a perspective view illustrating an end portion of the first processing head unit 2 of the laser processing head 1 according to a eleventh modification of the first embodiment, the end portion facing the second processing head unit 3. FIG. 39 is a perspective view illustrating an end portion of the second processing head unit 3 of the laser processing head 1 according to the eleventh modification of the first embodiment, the end portion facing the first processing head unit 2. As illustrated in FIGS. 38 and 39, in the present modification, the movable pins 4 are provided on the second plate portion 3b, and the magnets 6 are provided on the first plate portion 2b. That is, the movable pins 4 and the magnets 6 are provided on different plate portions. In a case of employing such a configuration, the movable pins 4 and the magnets 6 are preferably disposed at positions where the movable pins 4 and the magnets 6 do not interfere with each other when the second processing head unit 3 slides to move. It is preferable that the magnets 6 and the movable pins 4 be disposed not collinearly along the inclination direction. Three movable pins 4 are disposed at positions closer to the first center line Ca than the magnets 6 in the present modification. The number of movable pins 4 illustrated in FIG. 39 is three. Two movable pins 4 are provided above the portion of the second inclined surface 3c where the optical path hole 1a is opened in the inclination direction. One movable pin 4 is provided below the portion of the second inclined surface 3c where the optical path hole 1a is opened in the inclination direction. The one movable pin 4 is disposed on the first center line Ca in the present modification.

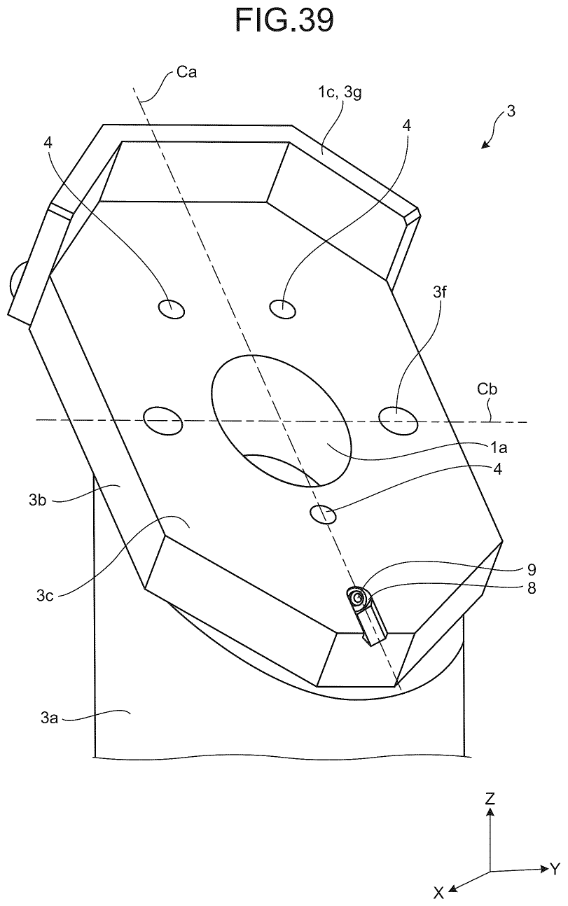

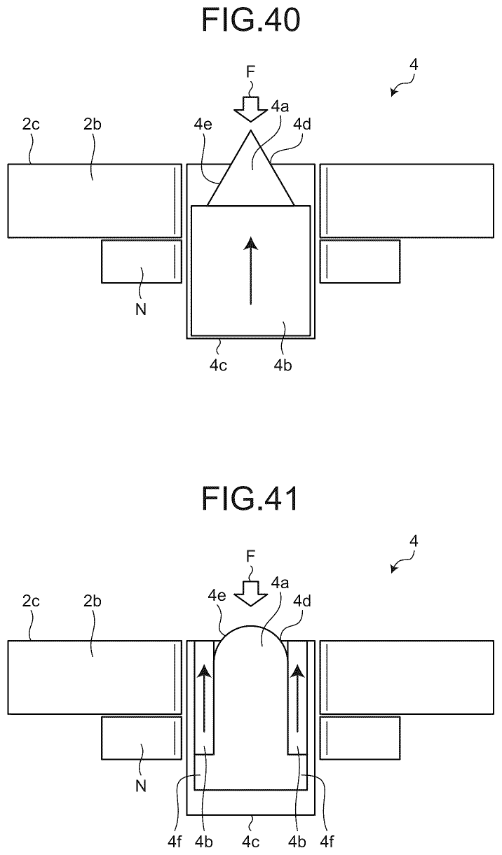

The configuration of the movable pin 4 is not limited to that in the illustrated example, and may be appropriately changed. For example, the configuration of the movable pin 4 may be a configuration as illustrated in FIG. 40. FIG. 40 is a view schematically illustrating the movable pin 4 of the laser processing head 1 according to a twelfth modification of the first embodiment. The movable pin-side contact surface 4e of the movable component 4a illustrated in FIG. 40 is formed in a conical shape whose diameter decreases from the proximal end side toward the distal end side of the movable component 4a. Note that the shape of the movable pin-side contact surface 4e may be a truncated cone shape or the like whose diameter decreases from the proximal end side toward the distal end side of the movable component 4a.

For example, the configuration of the movable pin 4 may be a configuration as illustrated in FIG. 41. FIG. 41 is a view schematically illustrating the movable pin 4 of the laser processing head 1 according to a thirteenth modification of the first embodiment. Hereinafter, differences from the first embodiment described above will be mainly described. The movable pin 4 includes the movable component 4a, the energizing means 4b, and the container 4c. The container 4c is a bottomed cylindrical member. The container 4c is formed with an opening 4d for allowing the movable component 4a to protrude therefrom. A proximal end of the movable component 4a is formed with a seat 4f that juts in a direction perpendicular to the axis of the movable component 4a as compared with other portions. The energizing means 4b is disposed between the seat 4f of the movable component 4a and an opening edge of the container 4c, and serves to energize the movable component 4a in a direction protruding from the opening 4d of the container 4c.

In the present modification, the movable pin 4 is a pulling-type movable pin of which the movable component 4a is pulled in the direction protruding from the opening 4d of the container 4c. When an external force F applied to the movable pin-side contact surface 4e of the movable component 4a exceeds an energizing force of the energizing means 4b, the movable component 4a is pushed toward the bottom of the container 4c. On the other hand, when the external force F applied to the movable pin-side contact surface 4e of the movable component 4a is removed, the movable component 4a is pulled toward the opening 4d of the container 4c by the energizing force of the energizing means 4b, and the movable component 4a returns to the original shape thereof.

The shape of the pin seat 5 is not limited to that in the illustrated example, and may be appropriately changed. For example, the shape of the pin seat 5 may be a shape as illustrated in FIG. 42. FIG. 42 is a perspective view illustrating an end portion of the second processing head unit 3 of the laser processing head 1 according to a fourteenth modification of the first embodiment, the end portion facing the first processing head unit 2. The shape of the pin seat 5 illustrated in FIG. 42 may be a groove shape. In the present modification, the pin seat 5 has a groove shape of which length in the orthogonal direction is longer than that in the inclination direction. In a case where the pin seat 5 has such a shape, the length dimension of the pin seat 5 along the orthogonal direction is larger than the thickness dimension of the movable pin 4. Note that the shape of the pin seat 5 may be, for example, a groove shape of which length in the inclination direction is longer than that in the orthogonal direction. In a case where the pin seat 5 has such a shape, the length dimension of the pin seat 5 along the inclination direction is larger than the thickness dimension of the movable pin 4. In a case of employing a groove shape as the shape of the pin seat 5, the shape of the pin seat 5 may be a V shape, a U shape, an arc shape, or the like symmetrical with respect to the groove width direction. A configuration may be employed in which the pin seat 5 in a groove shape of which length in the orthogonal direction is longer than that in the inclination direction and the pin seat 5 in a groove shape of which length in the inclination direction is longer than that in the orthogonal direction are used in combination.

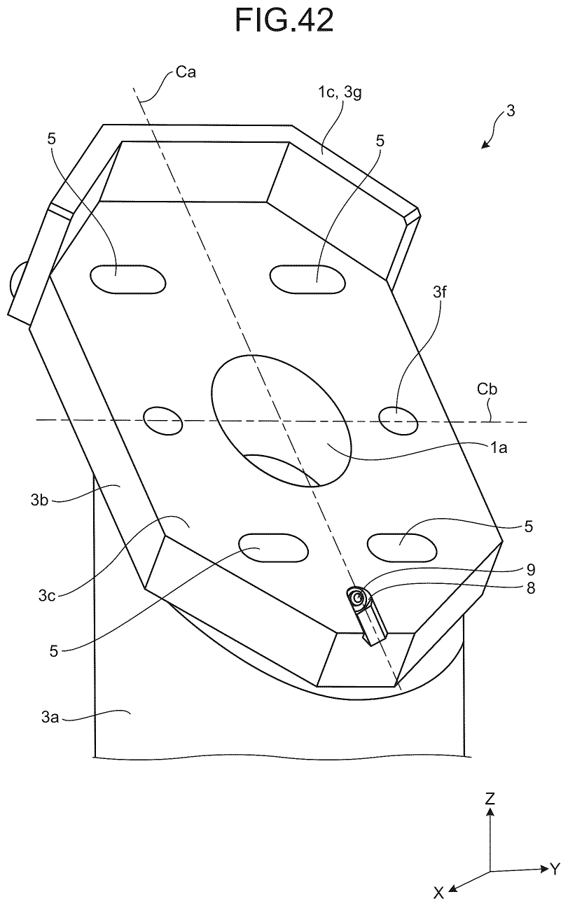

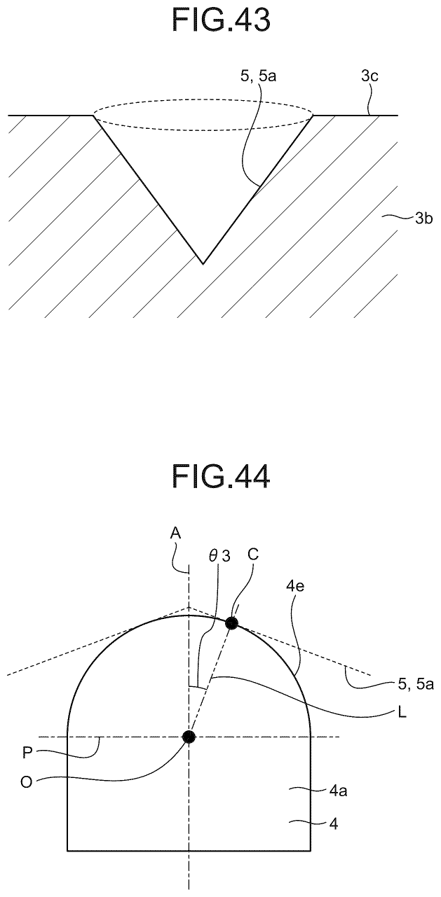

For example, the shape of the pin seat 5 may be a shape as illustrated in FIG. 43. FIG. 43 is a view schematically illustrating the pin seat 5 of the laser processing head 1 according to a fifteenth modification of the first embodiment. In the present modification, the pin seat 5 illustrated in FIG. 43 has a conical shape. On the inner surface of the pin seat 5, the pin seat-side contact surface 5a in a conical shape is formed. Note that the shape of the pin seat 5 may be a truncated cone shape or the like.

FIG. 44 is an explanatory view for explaining a contact point C between the movable pin 4 and the pin seat 5. FIG. 45 is an explanatory view for explaining the contact point C between the movable pin 4 and the pin seat 5, and is a view illustrating a case where a position of the contact point C is different from that in FIG. 44. The movable pin-side contact surface 4e is formed in a shape having a central axis A. The movable pin-side contact surface 4e is formed in an axisymmetric shape with respect to the central axis A. Here, a virtual straight line passing through a terminal on a proximal end side of the movable pin-side contact surface 4e and the central axis A and perpendicular to the central axis A is defined as a perpendicular line P. A point where the central axis A intersects the perpendicular line P is defined as an intersection O. A contact point between the movable pin-side contact surface 4e and the pin seat-side contact surface 5a is defined as the contact point C. A virtual line connecting the intersection O and the contact point C is defined as a virtual straight line L. An angle formed by the central axis A and the virtual straight line L is defined as a contact angle θ3.

For example, in a case where the movable pin-side contact surface 4e of the movable pin 4 is hemispherical, if the contact angle θ3 is small, there is a possibility that when the laser processing head 1 moves at a high speed, the second processing head unit 3 is caused to move and thus the position thereof with respect to the first processing head unit 2 is deviated. On the other hand, if the contact angle θ3 is too large, there is a possibility that when the second processing head unit 3 slides to move at the time of the downward collision of the laser processing head 1, the movable component 4a is not pushed and the movable pin 4 is damaged. In consideration of the above points, the contact angle θ3 is preferably 55 degrees to 75 degrees,

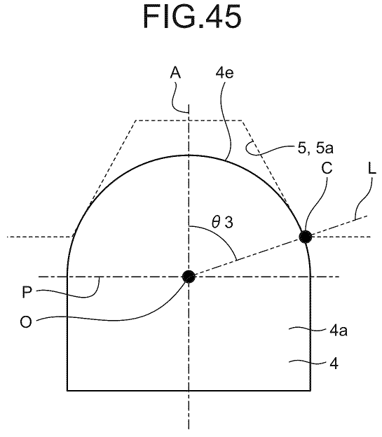

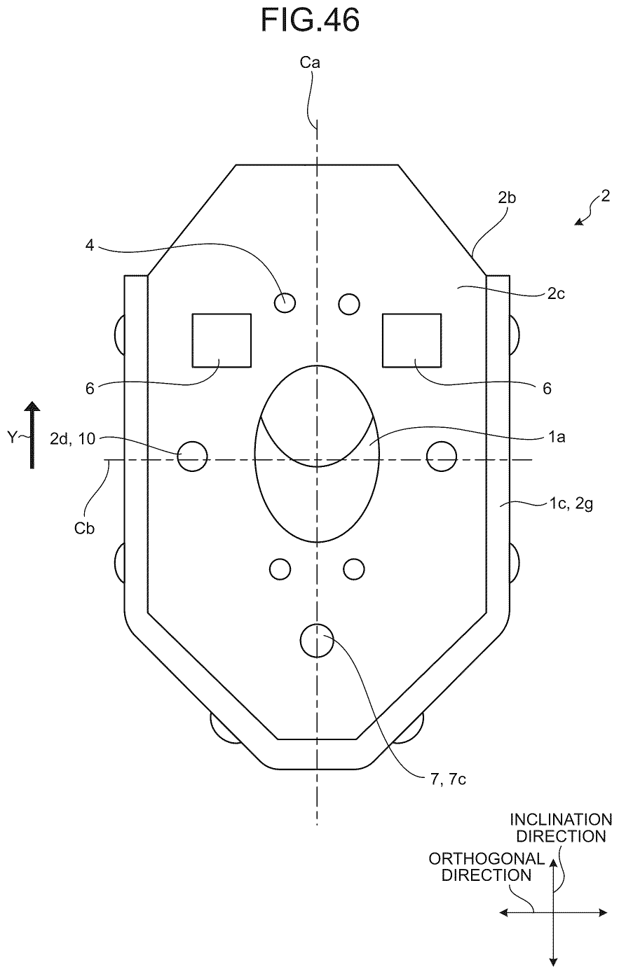

The disposition of the magnets 6 is not limited to that in the illustrated example, and may be appropriately changed. For example, the disposition of the magnets 6 may be disposition as illustrated in FIG. 46. FIG. 46 is a plan view illustrating an end portion of the first processing head unit 2 of the laser processing head 1 according to a sixteenth modification of the first embodiment, the end portion facing the second processing head unit 3, The number of magnets 6 illustrated in FIG. 46 is two. The two magnets 6 are disposed above the second center line Cb in the inclination direction. The two magnets 6 are disposed collinearly along the orthogonal direction. The magnets 6 are disposed one by one at positions offset from the first center line Ca on one side and the other side of the first center line Ca in the orthogonal direction.

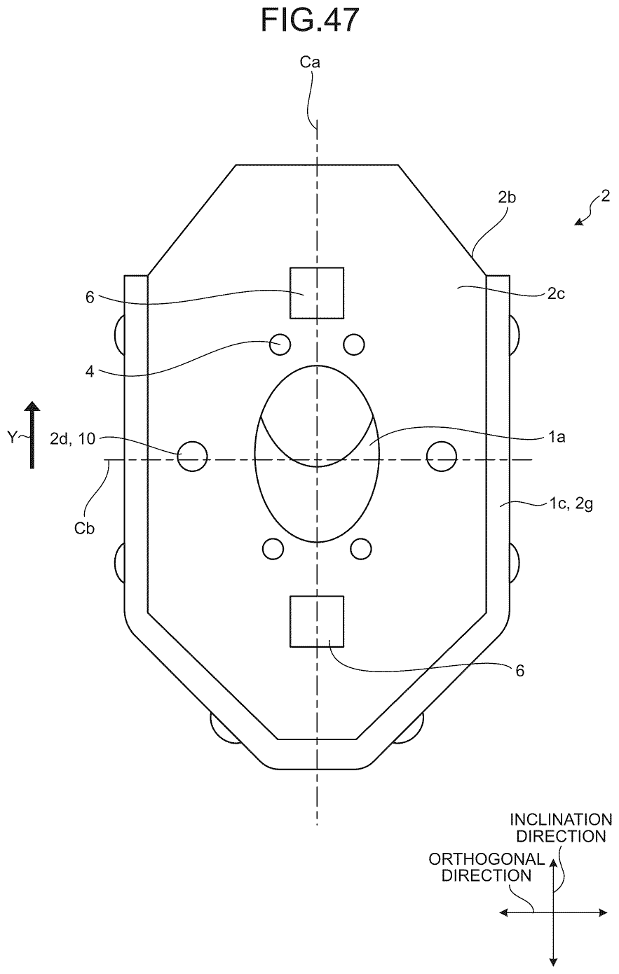

For example, the disposition of the magnets 6 may be disposition as illustrated in FIG. 47. FIG. 47 is a plan view illustrating an end portion of the first processing head unit 2 of the laser processing head 1 according to a seventeenth modification of the first embodiment, the end portion facing the second processing head unit 3. The number of magnets 6 illustrated in FIG. 47 is two. The two magnets 6 are disposed one by one above and below the portion of the first inclined surface 2c where the optical path hole 1a is opened in the inclination direction. The two magnets 6 are disposed collinearly along the inclination direction. The two magnets 6 are disposed on the first center line Ca.

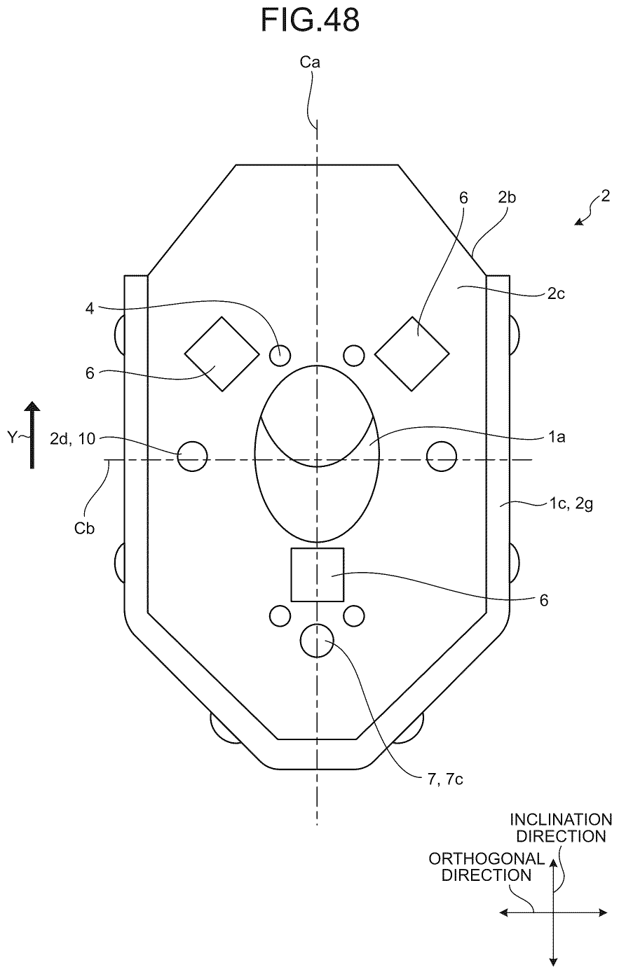

For example, the disposition of the magnets 6 may be disposition as illustrated in FIG. 48. FIG. 48 is a plan view illustrating an end portion of the first processing head unit 2 of the laser processing head 1 according to an eighteenth modification of the first embodiment, the end portion facing the second processing head unit 3, The number of magnets 6 illustrated in FIG. 48 is three. The three magnets 6 are disposed to be spaced from one another in a circumferential direction of the portion of the first inclined surface 2c where the optical path hole 1a is opened. One magnet 6 is disposed below the portion of the first inclined surface 2c where the optical path hole 1a is opened in the inclination direction, and two magnets 6 are disposed obliquely above the portion of the first inclined surface 2c where the optical path hole 1a is opened in the inclination direction.

One magnet 6 disposed lowermost in the inclination direction is disposed on the first center line Ca. The remaining two magnets 6 are disposed at positions offset from the first center line Ca on one side and the other side of the first center line Ca in the orthogonal direction. The remaining two magnets 6 are disposed to be line-symmetric with respect to the first center line Ca. The remaining two magnets 6 are inclined so as to approach the first center line Ca from the lower side toward the upper side in the inclination direction.

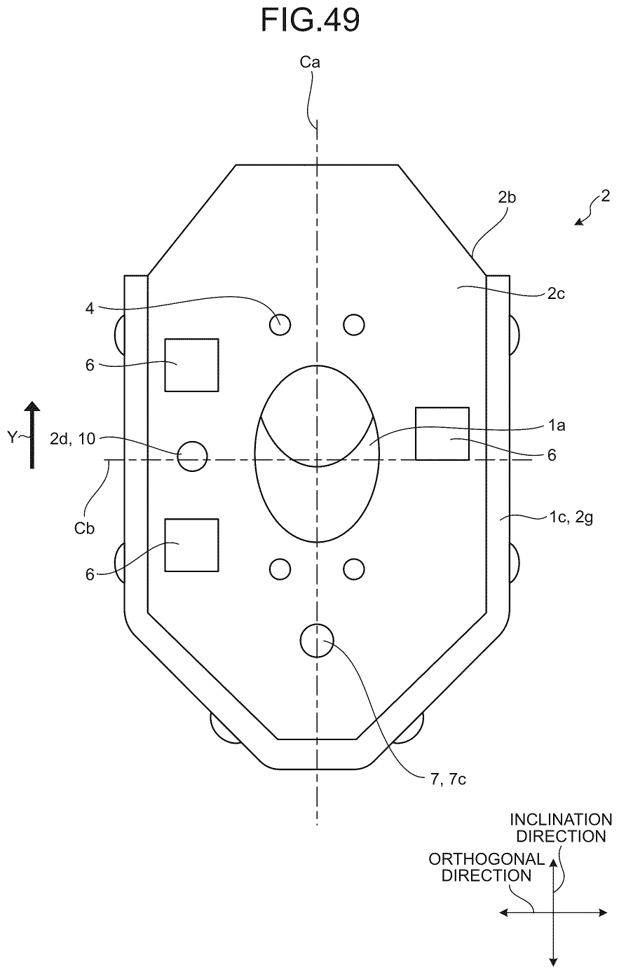

For example, the disposition of the magnets 6 may be disposition as illustrated in FIG. 49. FIG. 49 is a plan view illustrating an end portion of the first processing head unit 2 of the laser processing head 1 according to a nineteenth modification of the first embodiment, the end portion facing the second processing head unit 3. The number of magnets 6 illustrated in FIG. 49 is three. Two magnets 6 are disposed on one side of the portion of the first inclined surface 2c where the optical path hole 1a is opened in the orthogonal direction, and one magnet 6 is disposed on the other side thereof in the orthogonal direction. The two magnets 6 disposed on one side thereof in the orthogonal direction are disposed collinearly along the inclination direction, and are disposed at positions offset from the second center line Cb above and below the second center line Cb in the inclination direction.

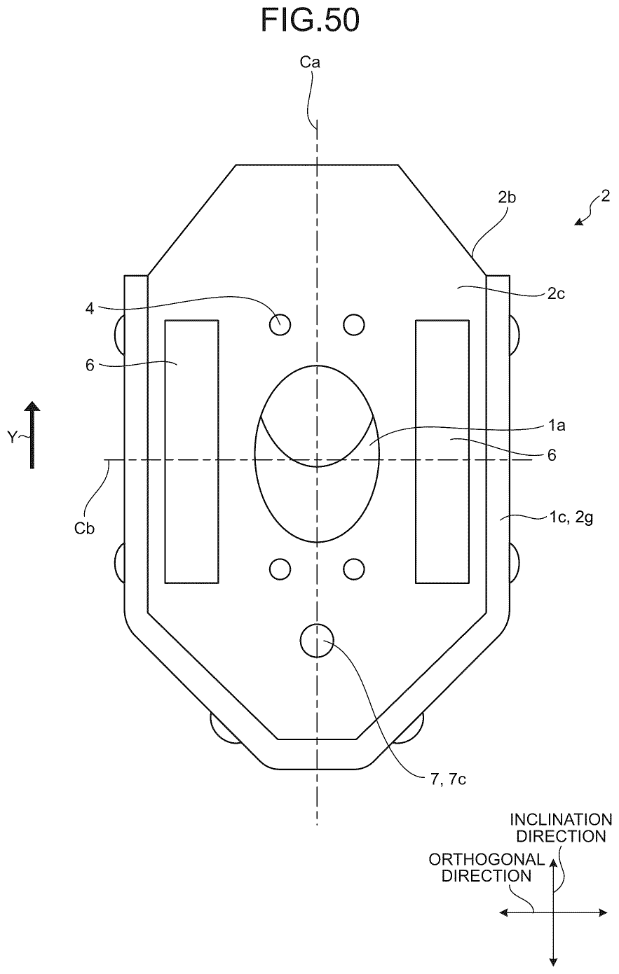

For example, the disposition of the magnets 6 may be disposition as illustrated in FIG. 50. FIG. 50 is a plan view illustrating an end portion of the first processing head unit 2 of the laser processing head 1 according to a twentieth modification of the first embodiment, the end portion facing the second processing head unit 3. The number of magnets 6 illustrated in FIG. 50 is two. The magnets 6 are disposed one by one on one side and the other side of the portion of the first inclined surface 2c where the optical path hole 1a is opened in the orthogonal direction. The two magnets 6 are disposed collinearly along the orthogonal direction. The two magnets 6 are disposed on the second center line Cb. The two magnets 6 are each disposed in a state in which the length direction coincides with the inclination direction and the width direction coincides with the orthogonal direction.

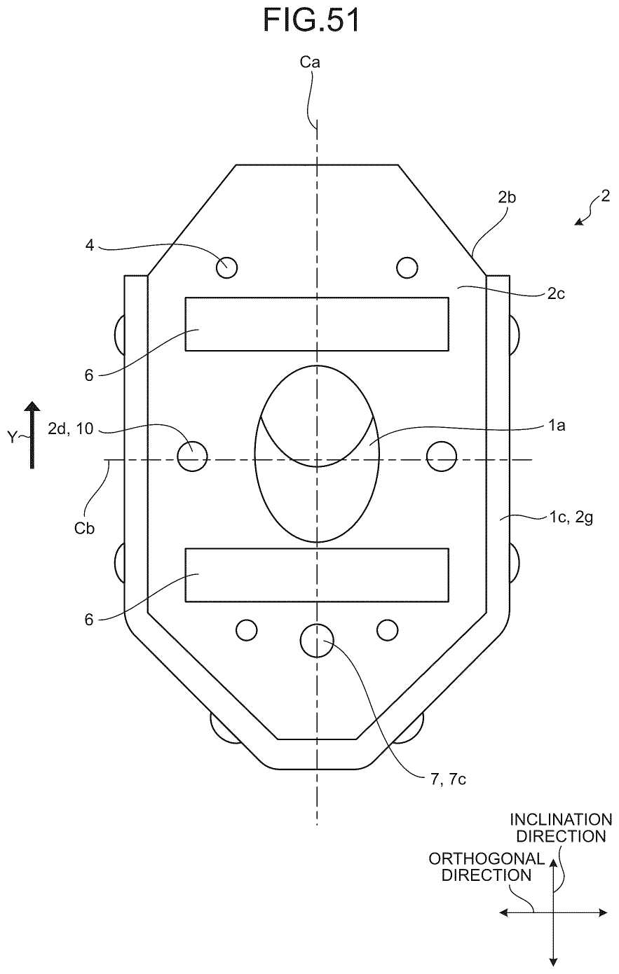

For example, the disposition of the magnets 6 may be disposition as illustrated in FIG. 51. FIG. 51 is a plan view illustrating an end portion of the first processing head unit 2 of the laser processing head 1 according to a twenty-first modification of the first embodiment, the end portion facing the second processing head unit 3. The number of magnets 6 illustrated in FIG. 51 is two. The magnets 6 are disposed one by one above and below the portion of the first inclined surface 2c where the optical path hole 1a is opened in the inclination direction. The two magnets 6 are disposed collinearly along the inclination direction. The two magnets 6 are disposed on the first center line Ca. The two magnets 6 are each disposed in a state in which the length direction coincides with the orthogonal direction and the width direction coincides with the inclination direction.

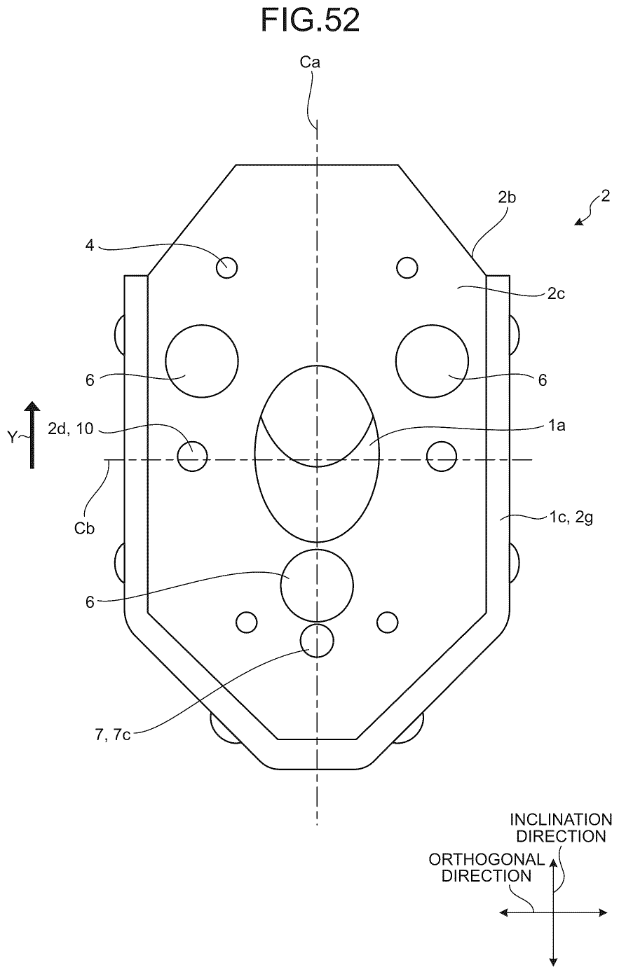

For example, the disposition of the magnets 6 may be disposition as illustrated in FIG. 52. FIG. 52 is a plan view illustrating an end portion of the first processing head unit 2 of the laser processing head 1 according to a twenty-second modification of the first embodiment, the end portion facing the second processing head unit 3. The number of magnets 6 illustrated in FIG. 52 is three. The shape of the magnets 6 is a circular shape. The three magnets 6 are disposed to be spaced from one another in a circumferential direction of the portion of the first inclined surface 2c where the optical path hole 1a is opened. One magnet 6 is disposed below the portion of the first inclined surface 2c where the optical path hole 1a is opened in the inclination direction, and two magnets 6 are disposed obliquely above the portion of the first inclined surface 2c where the optical path hole 1a is opened in the inclination direction. One magnet 6 disposed lowermost in the inclination direction is disposed on the first center line Ca. The remaining two magnets 6 are disposed at positions offset from the first center line Ca on one side and the other side of the first center line Ca in the orthogonal direction. The remaining two magnets 6 are disposed to be line-symmetric with respect to the first center line Ca.

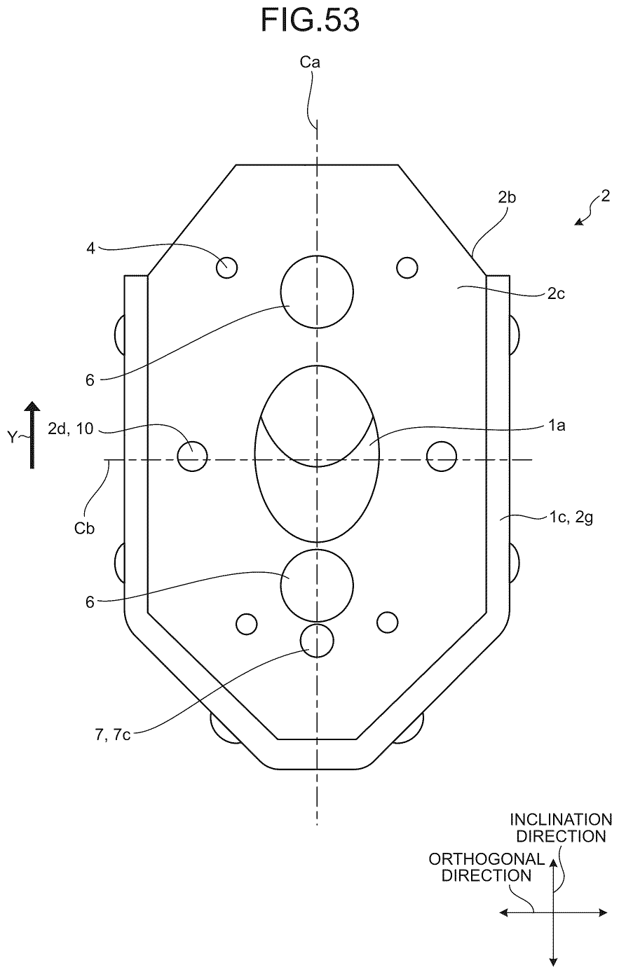

For example, the disposition of the magnets 6 may be disposition as illustrated in FIG. 53. FIG. 53 is a plan view illustrating an end portion of the first processing head unit 2 of the laser processing head 1 according to a twenty-third modification of the first embodiment, the end portion facing the second processing head unit 3, The number of magnets 6 illustrated in FIG. 53 is two. The shape of the magnets 6 is a circular shape. The two magnets 6 are disposed one by one above and below the portion of the first inclined surface 2c where the optical path hole 1a is opened in the inclination direction. The two magnets 6 are disposed collinearly along the inclination direction. The two magnets 6 are disposed on the first center line Ca.

The configuration of the magnet 6 is not limited to that in the illustrated example, and may be appropriately changed. For example, the configuration of the magnet 6 may be a configuration as illustrated in FIGS. 54 and 55, FIG. 54 is a perspective view illustrating the magnet 6 of the laser processing head 1 according to a twenty-ninth modification of the first embodiment. FIG. 55 is a cross-sectional view illustrating a state in which the magnet 6 illustrated in FIG. 54 is disposed in the first processing head unit 2. As illustrated in FIG. 54, the magnet 6 sandwiched between a pair of yokes 6b may be used as an attraction member. The magnet 6 is magnetized in a thickness direction of the magnet 6. The pair of yokes 6b sandwich the magnet 6 from both sides of the magnet 6 in the thickness direction. The shapes of the magnet 6 and the yokes 6b are not particularly limited, and a plate-like shape is employed in the present modification.

As illustrated in FIG. 55, the magnet 6 and the pair of yokes 6b are each disposed in the mounting hole 2e of the first inclined surface 2c so as to face the second inclined surface 3c. A magnetic flux M generated from the magnet 6 flows through one yoke 6b and then flows to the second plate portion 3b. Next, the magnetic flux M flows from the second plate portion 3b to the other yoke 6b, and then returns to the magnet 6. As described above, the magnetic flux flows around the magnet 6, one yoke 6b, the second plate portion 3b, the other yoke 6b, and the magnet 6 in this order.

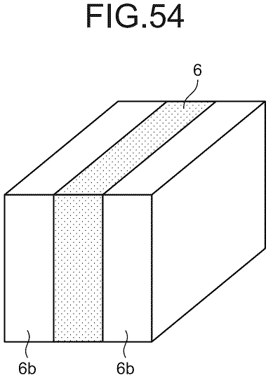

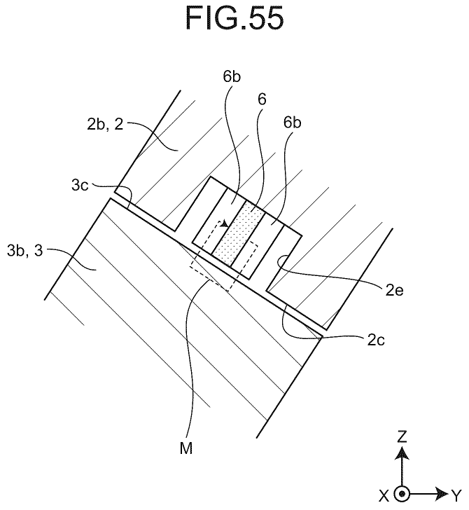

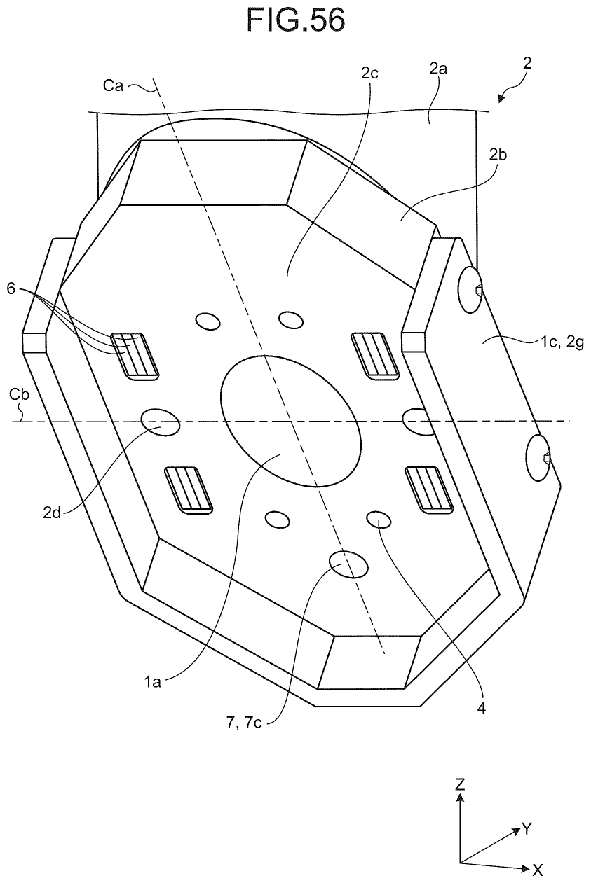

For example, the configuration of the magnet 6 may be a configuration as illustrated in FIG. 56. FIG. 56 is a perspective view illustrating an end portion of the first processing head unit 2 of the laser processing head 1 according to a twenty-fifth modification of the first embodiment, the end portion facing the second processing head unit 3. As illustrated in FIG. 56, an object obtained by integrating a plurality of magnets 6 with an adhesive may be used as an attraction member. The number of magnets 6 to be integrated is three in the present modification. Four sets of magnets 6, each set including three magnets 6 are disposed in the present modification. The three magnets 6 are stacked in the thickness direction of the magnets 6. The adjacent magnets 6 are coupled via the adhesive. The three magnets 6 are each disposed in the mounting hole 2e of the first inclined surface 2c so as to face the second inclined surface 3c.

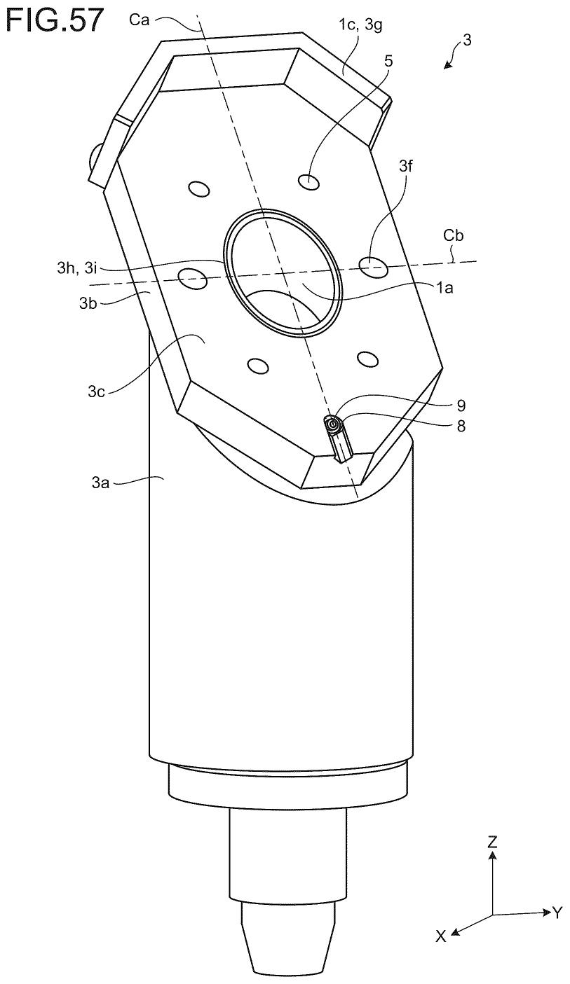

FIG. 57 is a perspective view illustrating the second processing head unit 3 of the laser processing head 1 according to a twenty-sixth modification of the first embodiment. As illustrated in FIG. 57, the second inclined surface 3c may be provided with a seal member 3h. The seal member 3h is disposed so as to surround the portion of the second inclined surface 3c where the optical path hole 1a is opened. The seal member 3h hermetically seals between the first inclined surface 2c and the second inclined surface 3c. The seal member 3h is, for example, an O-ring. A seal groove 31 in which the seal member 3h is accommodated is formed on the second inclined surface 3c.

Although not illustrated, the seal member 3h is disposed at a position closer to the optical path hole 1a than the movable pins 4, the magnets 6, the contact sensor 7, the sensor abutment pin 9, and the like. As described above, the second inclined surface 3c is provided with the seal member 3h that is disposed so as to surround the opening of the optical path hole 1a and seals between the first inclined surface 2c and the second inclined surface 3c, and therefore, in the laser processing machine in which a gas is caused to flow through the optical path hole 1a at the time of machining, it is possible to prevent the gas from leaking out of the laser processing head 1 from between the first inclined surface 2c and the second inclined surface 3c. Note that the seal member 3h is only required to be provided on at least one of the first inclined surface 2c or the second inclined surface 3c. A plurality of seal members 3h having different diameters may multiply surround the opening of the optical path hole 1a.

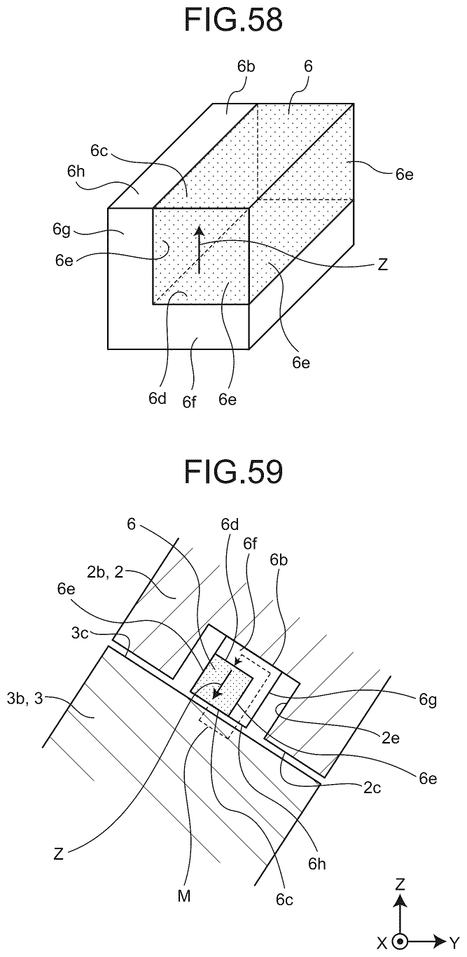

FIG. 58 is a perspective view illustrating the magnet 6 and the yoke 6b of the laser processing head 1 according to a twenty-seventh modification of the first embodiment. FIG. 59 is a cross-sectional view illustrating a state in which the magnet 6 and the yoke 6b illustrated in FIG. 58 are disposed in the first processing head unit 2. A solid arrow in FIG. 59 indicates a magnetization direction Z of the magnet 6. A dashed arrow in FIG. 59 indicates the magnetic flux M. As illustrated in FIG. 58, the attraction member may include the magnet 6 and the yoke 6b that allows the magnetic flux to pass therethrough. The shape of the magnet 6 is a quadrangular prism in the present modification. The magnet 6 includes a front surface 6c as an attraction surface, a back surface 6d, and four side surfaces 6e. The front surface 6c, the back surface 6d, and the four side surfaces 6e all have a rectangular shape.

As illustrated in FIG. 59, the attraction member including the magnet 6 and the yoke 6b is provided on the first inclined surface 2c. The front surface 6c is a surface facing the second inclined surface 3c. The back surface 6d is a surface facing a side opposite to the front surface 6c. Each of the side surfaces 6e is a surface connecting the front surface 6c and the back surface 6d. The front surface 6c and the back surface 6d are parallel to the second inclined surface 3c. Each of the side surfaces 6e is perpendicular to the second inclined surface 3c. The magnet 6 is magnetized in a direction toward the second inclined surface 3c. In other words, the magnet 6 is magnetized in a direction from the back surface 6d toward the front surface 6c.

As illustrated in FIG. 58, the yoke 6b has an L shape in the present modification. The yoke 6b includes a one-side portion 6f and an other-side portion 6g. The yoke 6b is in contact with the back surface 6d and one side surface 6e. The one-side portion 6f is in contact with the back surface 6d. The other-side portion 6g is in contact with one side surface 6e. As illustrated in FIG. 59, the other-side portion 6g is disposed below the magnet 6 in the inclination direction. A distal end surface 6h of the other-side portion 6g is a surface facing the second inclined surface 3c. Each of the magnet 6 and the yoke 6b is disposed in the mounting hole 2e of the first inclined surface 2c so as to face the second inclined surface 3c. When the first inclined surface 2c is viewed from the front of the first inclined surface 2c, the magnet 6 and the yoke 6b are disposed side by side along the inclination direction. Specifically, when the first inclined surface 2c is viewed from the front of the first inclined surface 2c, the front surface 6c of the magnet 6 and the distal end surface 6h of the yoke 6b are disposed side by side along the inclination direction.

The magnetic flux M generated from the magnet 6 flows from the magnet 6 to the second plate portion 3b. Next, the magnetic flux M flows from the second plate portion 3b to the yoke 6b, and then returns to the magnet 6 from the back surface 6d of the magnet 6. As described above, the magnetic flux M flows around the magnet 6, the second plate portion 3b, the yoke 6b, and the magnet 6 in this order. With the use of the L-shaped yoke 6b, it is possible to realize enhancement of a magnetic force by the magnet 6 and space saving for an installation place of the attraction member. Note that the attraction member including the magnet 6 and the yoke 6b is only required to be provided on any one of the first inclined surface 2c or the second inclined surface 3c. In a case where the attraction member including the magnet 6 and the yoke 6b is provided on the first inclined surface 2c, the front surface 6c is a surface facing the second inclined surface 3c. On the other hand, in a case where the attraction member including the magnet 6 and the yoke 6b is provided on the second inclined surface 3c, the front surface 6c is a surface facing the first inclined surface 2c. That is, the front surface 6c is a surface facing any one of the first inclined surface 2c and the second inclined surface 3c. In a case where the attraction member including the magnet 6 and the yoke 6b is provided on the second inclined surface 3c, the distal end surface 6h of the other-side portion 6g is a surface facing the first inclined surface 2c, and the magnet 6 is magnetized in a direction toward the first inclined surface 2c. The attraction member including the magnet 6 and the yoke 6b may be provided on both the first inclined surface 2c and the second inclined surface 3c. In the present modification, one magnet 6 and one yoke 6b are combined into one set, but the numbers of magnets 6 and yokes 6b in one set may be appropriately changed. In the present modification, the yoke 6b is fixed to the bottom surface of the mounting hole 2e, but the magnet 6 may be fixed to a side surface of the mounting hole 2e. In the present modification, each surface of the magnet 6 is a flat surface, but may not be a flat surface. In the present modification, adjacent surfaces of the magnet 6 are orthogonal to each other, but may not be orthogonal to each other.

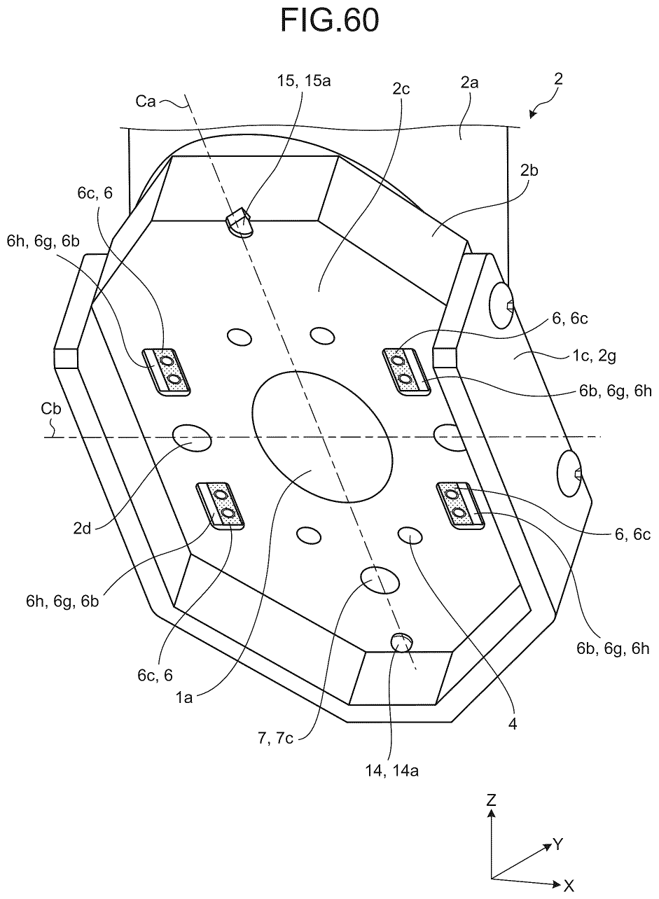

FIG. 60 is a perspective view illustrating an end portion of the first processing head unit 2 of the laser processing head 1 according to a twenty-eight modification of the first embodiment, the end portion facing the second processing head unit 3. In the present modification, the disposition of the magnet 6 and the yoke 6b is different from that in the above-described twenty-seventh modification. As illustrated in FIG. 60, when the second inclined surface 3c is viewed from the front of the second inclined surface 3c, each magnet 6 and each yoke 6b may be disposed side by side along the orthogonal direction. Specifically, when the second inclined surface 3c is viewed from the front of the second inclined surface 3c, the front surface 6c of the magnet 6 and the distal end surface 6h of the yoke 6b may be disposed side by side along the orthogonal direction. In FIG. 60, one magnet 6 and one yoke 6b form one set as an attraction member, and four sets of attraction members are disposed in the present modification. However, the number of sets of attraction members may be appropriately changed.

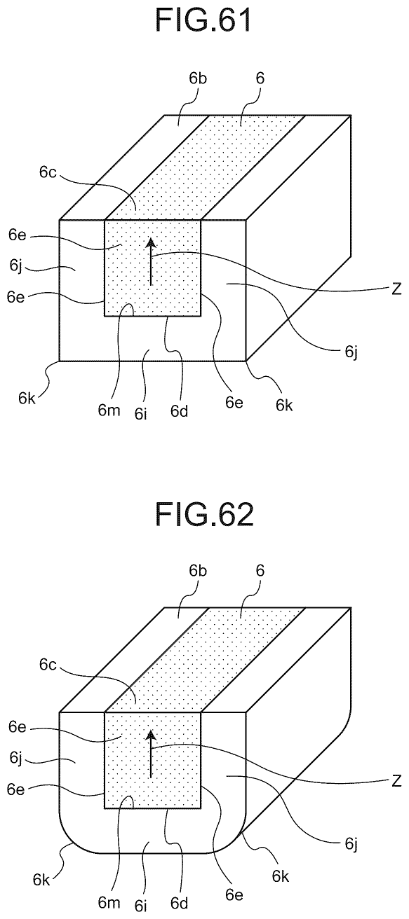

FIG. 61 is a perspective view illustrating the magnet 6 and the yoke 6b of the laser processing head 1 according to a twenty-ninth modification of the first embodiment. In the present modification, the shape of the yoke 6b is different from that in the above-described twenty-seventh modification. As illustrated in FIG. 61, the yoke 6b may have a recessed shape. The yoke 6b has a bottom portion 6i and two side portions 6j. The yoke 6b is in contact with the back surface 6d and a pair of side surfaces 6e. The bottom portion 6i is in contact with the back surface 6d. The pair of side portions 6j are in contact with different side surfaces 6e. The pair of side portions 6j are disposed with the magnet 6 interposed therebetween. One of the side portions 6j extends from one end portion along the width direction of the bottom portion 6i toward the front surface 6c. The other of the side portions 6j extends from the other end portion along the width direction of the bottom portion 6i toward the front surface 6c. Each external corner 6k constituted by the bottom portion 6i and the side portion 6j has a pointed shape. A portion surrounded by the bottom portion 6i and the pair of side portions 6j is a recess 6m. The magnet 6 is disposed in the recess 6m. The attraction member including the magnet 6 and the yoke 6b may be disposed on any one of the first inclined surface 2c or the second inclined surface 3c such that the width direction of the bottom portion 6i coincides with the inclination direction, or may be disposed on any one of the first inclined surface 2c or the second inclined surface 3c such that the width direction of the bottom portion 6i coincides with the orthogonal direction.

FIG. 62 is a perspective view illustrating the magnet 6 and the yoke 6b of the laser processing head 1 according to a thirtieth modification of the first embodiment. In the present modification, the shape of the yoke 6b is different from that in the above-described twenty-ninth modification. As illustrated in FIG. 62, each external corner 6k of the yoke 6b may be chamfered in a round shape. The external corner 6k has a curved shape.

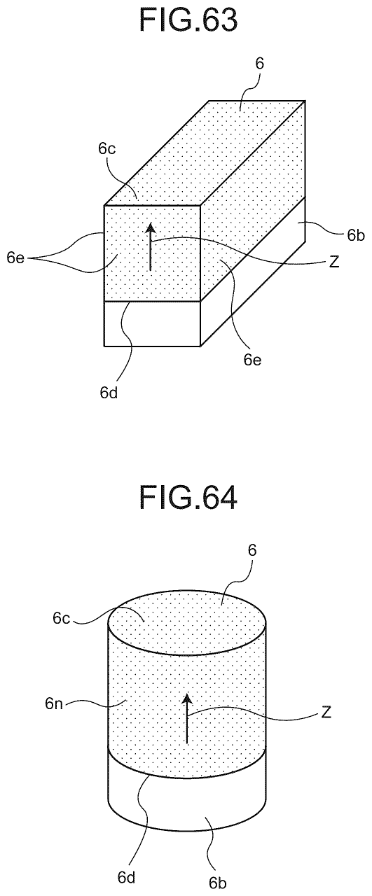

FIG. 63 is a perspective view illustrating the magnet 6 and the yoke 6b of the laser processing head 1 according to a thirty-first modification of the first embodiment. In the present modification, the shape of the yoke 6b is different from that in the above-described twenty-seventh modification. As illustrated in FIG. 63, the yoke 6b may have a plate shape. The yoke 6b is in contact only with the back surface 6d. The attraction member including the magnet 6 and the yoke 6b may be disposed on any one of the first inclined surface 2c or the second inclined surface 3c such that the width direction of the magnet 6 and the yoke 6b coincides with the inclination direction, or may be disposed on any one of the first inclined surface 2c or the second inclined surface 3c such that the width direction of the magnet 6 and the yoke 6b coincides with the orthogonal direction.

FIG. 64 is a perspective view illustrating the magnet 6 and the yoke 6b of the laser processing head 1 according to a thirty-second modification of the first embodiment. As illustrated in FIG. 64, the magnet 6 and the yoke 6b may have a columnar shape. The magnet 6 includes the front surface 6c as an attraction surface, the back surface 6d, and an outer peripheral surface 6n. The front surface 6c and the back surface 6d are both circular flat surfaces. The outer peripheral surface 6n is an annular surface connecting the front surface 6c and the back surface 6d. The diameter of the magnet 6 is the same as the diameter of the yoke 6b in the present modification, but may be different from the diameter of the yoke 6b. The length of the magnet 6 along the axial direction is longer than the length of the yoke 6b along the axial direction in the present modification. The magnet 6 and the yoke 6b are overlapped along the axial direction.

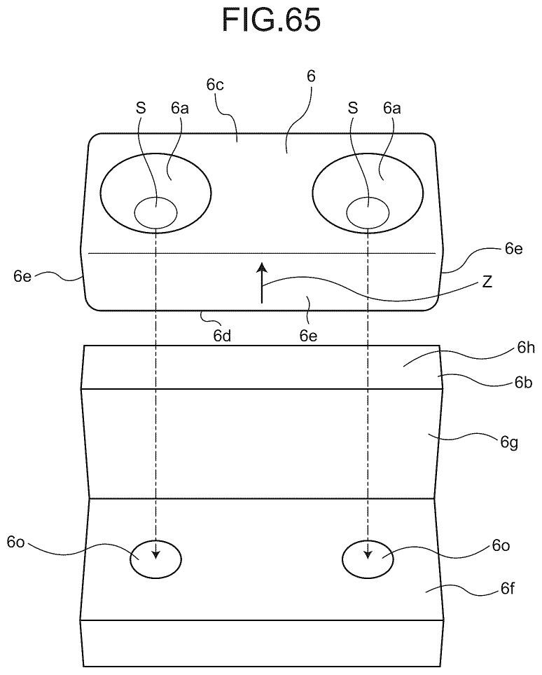

FIG. 65 is a perspective view illustrating the magnet 6 and the yoke 6b according to a thirty-third modification of the first embodiment. The magnet 6 is formed with screw holes 6a penetrating the magnet 6 in the thickness direction thereof. A screw S is inserted into each screw hole 6a. The yoke 6b has an L shape. The one-side portion 6f of the yoke 6b is formed with through holes 60 penetrating the one-side portion 6f in a thickness direction thereof. The screw S is inserted into each through hole 60. The magnet 6 and the yoke 6b are screwed together with the screw S to the first plate portion 2b of the first processing head unit 2 (not illustrated). That is, by screwing the screw S into each screw hole 6a of the magnet 6, each through hole 60 of the yoke 6b, and each screw hole 2f of the first plate portion 2b (not illustrated), the magnet 6 and the yoke 6b are collectively fixed to the first plate portion 2b. The magnet 6 is disposed, such that the front surface 6c faces one of the first inclined surface 2c or the second inclined surface 3c, on the other of the first inclined surface 2c or the second inclined surface 3c.

The configurations described in the embodiment above are merely examples and can be combined with other known technology and part of the configurations can be omitted or modified without departing from the gist thereof. In the above-described embodiment, the case where the laser processing machine is the additive manufacturing apparatus 100 has been described as an example, but the laser processing head 1 may be mounted on a laser processing machine other than the additive manufacturing apparatus 100. For example, as the laser processing machine other than the additive manufacturing apparatus 100, a laser cutting machine is exemplified.

### REFERENCE SIGNS LIST

1 laser processing head; 1a optical path hole; 1b flange; 1c cover; 2 first processing head unit; 2a first main body portion; 2b first plate portion; 2c first inclined surface; 2d first insertion hole; 2e mounting hole; 2g first cover; 3 second processing head unit; 3a second main body portion; 3b second plate portion; 3c second inclined surface; 3d nozzle; 3e cooling water joint; 3f second insertion hole; 3g second cover; 3h seal member; 31 seal groove; 4 movable pin; 4a movable component; 4b energizing means; 4c container; 4d opening; 4e movable pin-side contact surface; 4f seat; 5 pin seat; 5a pin seat-side contact surface; 6 magnet; 6a screw hole; 6b yoke; 6c front surface; 6d back surface; 6e side surface; 6f one-side portion; 6g other-side portion; 6h distal end surface; 61 bottom portion; 6j side portion; 6k external corner; 6m recess; 6n outer peripheral surface; 60 through hole; 7, 7a, 7b contact sensor; 7c contact portion; 8 Sensor groove; 9, 9a, 9b sensor abutment pin; 10, 11 fastening member; 12, 13 pin; 20 laser oscillator; 21 feeding mechanism; 21a wire spool; 21b rotary motor; 21c wire straightener; 21d wire feeder; 21e position adjustment mechanism; 22 CMT power supply; 23 gas injection device; 24 drive unit; 25 rotation shaft; 26 height sensor; 27 control device; 28 substrate; 29 shaped object; 30 stage; 31 fiber cable; 32 laser beam; 33 wire; 34 gas; 35 pipe; 36 support frame; 37 fastening structure; 100 additive manufacturing apparatus; N nut; S Screw.

1. A laser processing head that has an optical path hole formed therein for passing a laser beam and extends in a first direction, the laser processing head comprising:
a first processing head unit; and
a second processing head unit disposed side by side with the first processing head unit in the first direction and coupled to the first processing head unit in a separable manner, wherein
an end portion of the first processing head unit facing the second processing head unit is formed with a first inclined surface inclined with respect to the first direction,
an end portion of the second processing head unit facing the first processing head unit is formed with a second inclined surface parallel to the first inclined surface,
at least one of the first inclined surface or the second inclined surface is provided with an attraction member that couples the first processing head unit and the second processing head unit in a separable manner,
at least one of the first inclined surface or the second inclined surface is provided with a movable pin protruding toward another thereof and energized toward another thereof,
at least another of the first inclined surface or the second inclined surface is provided with a pin seat into which the movable pin is inserted, and
each of the movable pin and the pin seat is plural in number.

2. The laser processing head according to claim 1, wherein the movable pin is disposed at a position apart from the attraction member.

3. The laser processing head according to claim 1, wherein the movable pin and the attraction member are disposed only on the first inclined surface or only on the second inclined surface.

4. The laser processing head according to claim 1, wherein
the movable pin is provided on one of the first inclined surface or the second inclined surface,
the attraction member is provided on another of the first inclined surface or the second inclined surface, and
the movable pin and the attraction member are disposed not collinearly along a second direction that is an inclination direction of the first inclined surface and the second inclined surface.

5. The laser processing head according to claim 1, wherein
the movable pin is provided on the first inclined surface,
the attraction member is provided on the second inclined surface, and
the attraction member is disposed above the movable pin in a second direction that is an inclination direction of the first inclined surface and the second inclined surface.

6. The laser processing head according to claim 1, wherein
the movable pin is provided on the second inclined surface,
the attraction member is provided on the first inclined surface, and
the movable pin is disposed above the attraction member in a second direction that is an inclination direction of the first inclined surface and the second inclined surface.

7. The laser processing head according to claim 1, wherein the movable pin includes: a container in a bottomed cylindrical shape having an opening formed therein; a movable component that is movable in a direction protruding from the opening of the container and in a direction pushed to a bottom of the container; and an energizing means that energizes the movable component in a direction protruding from the opening of the container.

8. The laser processing head according to claim 1, wherein a movable pin-side contact surface tapered toward the pin seat is formed on the movable pin.

9. The laser processing head according to claim 1, wherein
at least one of the first inclined surface or the second inclined surface is formed with a mounting hole for accommodating the attraction member, and
the attraction member is located on a side farther apart from the first inclined surface or the second inclined surface facing the mounting hole than an opening of the mounting hole.

10. The laser processing head according to claim 1, wherein
at least one of the first inclined surface or the second inclined surface is provided with a sensor abutment pin, and
at least another of the first inclined surface or the second inclined surface is provided with a contact sensor that includes a contact portion in contact with the sensor abutment pin and senses, by displacement of the contact portion, positional deviation of the second processing head unit with respect to the first processing head unit.

11. The laser processing head according to claim 10, wherein the contact sensor provided on the first inclined surface is inclined so as to form an acute angle with the second inclined surface.

12. The laser processing head according to claim 10, wherein the contact sensor provided on the second inclined surface is inclined so as to form an acute angle with the first inclined surface.

13. The laser processing head according to claim 10, wherein
at least one of the first inclined surface or the second inclined surface is provided with a sensor groove that accommodates the sensor abutment pin, and
the sensor groove extends along a second direction that is an inclination direction of the first inclined surface and the second inclined surface.

14. The laser processing head according to claim 1, wherein
the first processing head unit includes a first main body portion extending in the first direction, and a first plate portion that is mounted on an end portion of the first main body portion facing the second processing head unit and is formed with the first inclined surface,
the second processing head unit includes a second main body portion extending in the first direction, and a second plate portion that is mounted on an end portion of the second main body portion facing the first processing head unit and is formed with the second inclined surface,
the first plate portion juts in a direction intersecting the first direction as compared with the first main body portion, and
the second plate portion juts in a direction intersecting the first direction as compared with the second main body portion.

15. The laser processing head according to claim 1, wherein
the first inclined surface and the second inclined surface have a same outer shape and a same outer peripheral dimension,
an end portion of the first processing head unit facing the second processing head unit is provided with a first cover along a lower edge and side edges of the first inclined surface,
an end portion of the second processing head unit facing the first processing head unit is provided with a second cover along an upper edge of the second inclined surface, and
when the first processing head unit and the second processing head unit are coupled to each other, the first cover and the second cover surround circumferences of the first inclined surface and the second inclined surface.

16. The laser processing head according to claim 1, wherein
the optical path hole is opened in the first inclined surface and the second inclined surface, and
at least one of the first inclined surface or the second inclined surface is provided with a seal member that is disposed so as to surround an opening of the optical path hole and seals between the first inclined surface and the second inclined surface.

17. The laser processing head according to claim 1, wherein
the attraction member includes a magnet, and a yoke that allows a magnetic flux to pass therethrough,
the attraction member is provided on one of the first inclined surface or the second inclined surface,
the magnet includes a front surface facing another of the first inclined surface or the second inclined surface, and a back surface facing a side opposite to the front surface, and
the yoke is in contact with the back surface.

18. A laser processing machine comprising:
a laser oscillator to generate a laser beam;
the laser processing head according to claim 1 to irradiate a workpiece with a laser beam generated by the laser oscillator; and
a drive unit to move the laser processing head.
